(19) United States
(12) Patent Application Publication
(10) Pub. No.: US 2023/0306497 A1
(43) Pub. Date: Sep. 28, 2023

(54) METHODS AND APPARATUS FOR INTEGRATING RETAIL APPLICATIONS AND RETAIL OPERATIONAL SUBSYSTEMS, AND OPTIMIZING OPERATION OF SAME

(71) Applicant: Walmart Apollo, LLC, Bentonville, AR (US)

(72) Inventors: John Lert, Wakefield, MA (US); William Fosnight, Windham, NH (US); Devin Lert, Virginia Beach, VA (US); Stephanie Waite, Glens Falls, NY (US); John Biasi, Lancaster, MA (US)

(21) Appl. No.: 18/114,150

(22) Filed: Feb. 24, 2023

Related U.S. Application Data
(60) Provisional application No. 63/314,277, filed on Feb. 25, 2022.

(51) Int. Cl. G06Q 30/0601; G06Q 10/0637

(52) U.S. Cl. CPC G06Q 30/0635; G06Q 10/06375

(57) ABSTRACT

Some embodiments provide retail facility control systems comprising: at least one retail operational subsystem comprising: an automated storage and retrieval system (ASRS) to automatically store and retrieve respective products in the ASRS and facilitate fulfillment of a customer order; a retail execution system to receive ASRS data and coupled to a plurality of retail applications to obtain customer-related data, associate-related data, and retail facility-related data; at least one data repository to store the ASRS data, the customer-related data, the associate-related data, and the retail facility-related data; a control circuit; and a solver module configured to be executed by the control circuit to: access business priorities and operational goals defined for a retail facility; and define a recommended operational plan intended to be implemented at the retail facility and predicted to enhance operation of the retail facility consistent with one or more business priorities and operational goals.

### CROSS-REFERENCE TO RELATED APPLICATION(S)

This application claims the benefit of U.S. Provisional Application No. 63/314,277 filed Feb. 25, 2022, which is incorporated herein by reference in its entirety.

### BACKGROUND

A conventional brick-and-mortar retail store is typically configured in a “self-serve” model where the store generally includes a range of products (also referred to herein as “items” or “goods”) that are put on display for customers to browse and select for purchase. When a customer shops at a brick-and-mortar store, they typically drive to the store using a vehicle, enter the store and begin shopping for the desired item(s) for purchase, purchase the item(s) at a checkout counter or kiosk, then exit the store and carry the purchased item(s) to their vehicle.

Some retail store operators have adopted an “E-commerce” model to provide an option for customers to purchase their products online. In the “E-commerce” model, a customer browses and purchases items using a software application or a website on a computing device (e.g., a desktop computer, a smartphone). Thus, customers may readily place an order for items from their home or other convenient location, which often saves the customer an appreciable amount of time compared to shopping at a brick-and-mortar store. Additionally, retailers that offer an E-commerce option may in some instances offer customers an even wider selection of items for purchase online compared to brick-and-mortar retail stores. Moreover, some retailers operate stores that provide customers with both a brick-and-mortar experience and an E-commerce option (a “hybrid” model); thus, customers may purchase some items online, while selecting other items in the store as they browse displayed products.

Conventionally there are multiple manners in which one or more items purchased in an online order are delivered to the customer. For example, online-only retailers may ship an order directly to the customer. However, this approach often increases the overall cost of an order since the customer is typically required to pay an additional shipping or membership fee or buy additional items so that the total cost of the order meets a specific threshold (e.g., to reduce or avoid a shipping fee). In another example, retailers that support an “E-commerce” model and also have brick-and-mortar stores (i.e., a “hybrid” model) may allow customers to pick up their online order directly at the store without any additional fees (e.g., when the customer goes to the store to select and purchase other items on display at the store).

### SUMMARY

The operation of the hybrid retail store and fulfillment of customer orders for pick up requires multiple hardware devices, software applications, human elements and various automation tools to be implemented and managed effectively. The Applicant has recognized and appreciated that the wider adoption of a hybrid model amongst retailers can provide significant opportunities to improve the customer shopping experience. At the same time, various inefficiencies and complexity for retailers exist in the management of this hybrid model, which could add undesirable overhead to the retailer operations.

Regarding conventional retail store operation, conventional retail stores often implement some form of a nominal operational plan in a piecemeal fashion for some contingent of available resources. For example, store associates are often scheduled to work on respective overlapping or contiguous shifts on different days to ensure adequate staffing based on empirical observations by management of customer traffic and/or inventory management requirements. Such nominal operational plans tend to be predetermined and/or relatively static for a given day or time period, and may be reiterated wholly or in part with some periodicity. However, if an operational plan needs to be changed, for example, in response to a change in operating conditions (e.g., surges in customer demand, unexpected/unforeseeable inventory issues, associate/staff shortages or unexpected absences, natural phenomena such as storms, etc.), the retail store generally is unable to respond or adapt to the changes in a timely manner, if at all.

The challenges faced by a conventional retail store to readily implement and adjust if necessary a holistic operational plan for the store itself and, in some cases, the greater retail ecosystem in which it operates is due, in part, to the respective resources (e.g., store associates, retail operational subsystems, retail software applications) generally being configured to operate as standalone systems or, at best, partially-integrated systems. Said in another way, conventionally speaking, respective retail operational subsystems or retail applications do not necessarily communicate information or data to other retail operational subsystems or retail applications in a cogent manner, if at all, let alone taken together with the coordination of store associates. For purposes of the present disclosure, a “retail operational subsystem” is a system that includes various hardware components and, in some cases, software components as well, whereas a “retail application” is a software application. Retail operational subsystems and retail applications provide respective functions to facilitate operation of the retail store, such as the creation of orders, payment of orders, or inventory management.

In connection with conventional retail operations, the Applicant has recognized and appreciated that diverse information (e.g., data) that may be available from respective retail operational subsystems and/or retail applications is not holistically collected, managed, normalized, or “centrally” stored to permit ready access of the information from which valuable insights may be gained; in particular, there is no centralized database of indexed normalized information germane to the multiple retail operational subsystems and/or retail applications (and the overall effective operation of the store) in a conventional retail environment, and there is no particular controller to utilize such information to facilitate dynamic and holistic operation of the retail store in a coordinated manner, and in response to a wide variety of evolving circumstances.

As a result of the foregoing, if a reallocation of resources in the retail store is needed, a store manager typically is required to manually determine the manner in which the resources should be reallocated, convey this information to one or more store associates, and/or adjust the operation of one or more retail operational subsystems on-the-fly. In one respect, such changes arising from management decision may occur with a relatively longer response time compared to the timescale at which the operating conditions are changing; i.e., meaningful changes in retail operations are effected too slowly and may ultimately have little impact (and/or unintended and undesirable consequences). In another aspect, the store manager may only have at their disposal a relatively limited amount of information associated with the retail operational subsystems, retail applications, and/or changing conditions and may thus adjust the operation of the retail store in a manner that fails to effectively address the change in circumstances evolving in the retail store. Moreover, inevitably a store manager will not make purely objective decisions regarding changes in an operational plan, but rather will likely make such decisions with some degree of bias (e.g., based on past experience and/or various assumptions).

In view of the foregoing challenges of operating a retail store, the Applicant has recognized and appreciated that certain prospective inefficiencies and costs associated with the operation of a hybrid retail store can be significantly reduced, if not substantially mitigated, if the hybrid retail store is managed in a holistic, integrated and significantly automated manner - effectively as a machine in and of itself. Thus, the inventive implementations disclosed herein generally relate to effective automated management of a hybrid retail store to significantly improve overall customer experience as well as efficiency and profitability for retail store operators.

In some implementations discussed in greater detail below, a hybrid retail store according to the inventive concepts disclosed herein may include a retail execution system to facilitate the integration of one or more retail operational subsystems, one or more retail applications, and one or more data repositories. The retail execution system may generally include one or more computing devices communicatively coupled to the retail operational subsystems. This allows the retail execution system to acquire and consolidate any available data associated with each operational subsystem in a centralized manner, for example, using a data repository. Furthermore, the retail execution system may also send commands and/or instructions to each operational subsystem, in part, to change the operation of the retail operational subsystem (e.g., by adjusting an operating parameter of a hardware component, by sending instructions to an associate operating the hardware component). Thus, the retail execution system provides the functional connections that allow the retail store to operate more like a single, integrated machine and thereby implement, execute, and/or modify an operational plan in a highly automated manner.

Such a retail execution system further may provide support for one or more retail applications, which may be software applications developed, in part, to facilitate various constituents in a retail environment (e.g., the retailer itself, customers, store associates, third-party vendors, customer delivery services, inventory transport and distribution services) to engage in the retail environment, and/or software applications to assess the operating status of the retail store and determine the extent any changes should be made in the operation of the various retail operational subsystems. Thus, the various retail applications can thus provide a wealth of useful data germane to the retail environment and, more particularly, management of the retail store and effective implementation of an operational plan for the retail store. For example, the retail execution system may communicate with and have access to a given retail application that may be associated with one or more of the operational subsystems, another retail application that may be associated with customers (e.g., a mobile customer ordering app), and another retail application that may be associated with a third-party (e.g., an in-store restaurant or service counter, or a “gig economy” app such as Uber Eats or DoorDash). In this manner, the retail execution system can allow real-time interoperability across retail applications and retail operational subsystems, which, in turn, allows the retail store to be readily configured to support multiple use cases and/or operational plans.

Although various example implementations of a retail execution system or, more generally, an automated management system are discussed in the context of a hybrid model retail store, it should be readily appreciated by those of ordinary skill in the art that the various concepts disclosed herein similarly have applicability to a wide variety of retail environments that may or may not include various degrees of automation. For example, the inventive concepts disclosed herein are applicable to retail stores that only adopt a “self-serve” model. In another example, the concepts disclosed herein are applicable to retail stores that only adopt an “E-commerce” model.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates multiple exemplary retail applications, exemplary retail operational subsystems and retail data type examples associated with one or more retail facilities (such as retail stores, also referred to herein as a “retail site” or a “market”), with a retail execution system that interfaces with the applications, operational subsystems and data to facilitate operation of the retail store, according to various inventive implementations of the present application.

FIG. 2 shows an exemplary retail supply chain that includes multiple retail stores, in which data can be shared between at least some of the retail stores, according to the inventive concepts discussed herein.

FIG. 3 is a block diagram of the exemplary retail execution system of FIG. 1 with additional details showing input/output (I/O) interfaces between example retail applications and example retail operational subsystems as well as internal functional components of the controller, according to various inventive implementations of the present application.

FIG. 4 is a block diagram of an example retail store with a retail execution system, according to various inventive implementations of the present application.

FIG. 5 shows a block diagram of an example retail store with a retail execution system that can be communicatively coupled to enterprise software, third party software, and a network operations center, according to various inventive implementations of the present application.

FIG. 6 shows a block diagram of another example retail store that includes off-site software applications communicatively coupled to on-site software applications including a site optimization application, according to various inventive implementations of the present application.

FIG. 7 shows a flow chart of an example method for adjusting an operational plan of a retail store to satisfy one or more business priorities and/or operational goals pursuant to the site optimization application shown in FIG. 6, according to various inventive implementations of the present application.

FIG. 8 illustrates a simplified flow diagram of an exemplary process of controlling one or more retail facilities, in accordance with some embodiments.

FIG. 9 illustrates a simplified flow diagram of an exemplary process of controlling retail facilities, in accordance with some embodiments.

FIG. 10 illustrates a simplified flow diagram of an exemplary process of controlling retail facilities in accordance with some embodiments.

FIG. 11 illustrates a simplified flow diagram of an exemplary process of controlling operations at one or more retail facilities, in accordance with some embodiments.

FIG. 12 illustrates a simplified flow diagram of an exemplary process of controlling retail facilities, in accordance with some embodiments.

FIG. 13 illustrates a simplified flow diagram of an exemplary process of controlling retail facilities, in accordance with some embodiments.

FIG. 14 illustrates an exemplary system for use in implementing methods, techniques, devices, apparatuses, systems, servers, sources and providing control over one or more retail facilities, in accordance with some embodiments.

### DETAILED DESCRIPTION

Following below are more detailed descriptions of various concepts related to, and implementations of, a retail execution system that communicatively couples to one or more retail operational subsystems of a retail store (also referred to herein as a “retail site” or “market”) to facilitate control of, and consolidate and share data associated with, respective retail operational subsystems and to further support one or more retail applications that utilize the data, in part, to adjust and improve operation of the retail store. Additional detailed descriptions of methods for operating a retail store using a retail execution system and/or improving operation of the retail store are also disclosed. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive retail execution systems and retail stores using retail execution systems are provided, wherein a given example or set of examples showcases one or more particular features of multiple retail-oriented application programming interfaces (APIs), a workflow manager, an event tracker, one or more data repositories, multiple retail operational subsystems, and multiple retail applications. It should be appreciated that one or more features discussed in connection with a given example of a retail execution system and/or a retail store may be employed in other examples of retail execution systems and/or retail stores according to the present disclosure, such that the various features disclosed herein may be readily combined in a given retail execution system and/or retail store according to the present disclosure (provided that respective features are not mutually inconsistent).

### 1. Overview of a Retail Execution System for a Hybrid Model Retail Store

In one illustrative example, a retail store is configured in a “hybrid” model that provides customers with both a self-serve option and an E-commerce option, in which customers may purchase some items online while selecting other items in the store as they browse displayed products. Example retail stores operating in a hybrid model may include automated equipment to facilitate fulfillment of online orders, as well as integration of online order fulfillment with in-store purchases.

According to some embodiments of the inventive concepts disclosed herein, a retail store can be operated holistically and efficiently in accordance with an operational plan pursuant to the architecture and functionality of a retail execution system. Although various example implementations of a retail execution system are discussed herein in the context of a hybrid model retail store, it should be readily appreciated by those of ordinary skill in the art that the various concepts disclosed herein similarly have applicability to a wide variety of retail environments that may or may not include various degrees of automation.

In one aspect, the implementation of an operational plan for a retail store as facilitated by a retail execution system allocates various resources in the retail store (e.g., store associates, automated equipment such as mobile robots) to various tasks, typically according to a schedule, in an effort to meet one or more objectives (e.g., fulfilling customer orders, maintaining appropriate inventory). Some tasks can be executed by store associates, based at least in part on one or more instructions/commands from the retail execution system. In addition, the retail execution system may facilitate the execution of other tasks by, or with the assistance of, one or more retail operational subsystems of the retail store (that involve various hardware components, in some cases together with software components), and/or one or more retail applications (i.e., software applications), which provide respective functions to facilitate operation of the retail store. Some conventional examples of retail operational subsystems include, but are not limited to, building infrastructure (e.g., HVAC, refrigeration) and automated ordering and payment kiosks; some conventional examples of retail software applications include, but are not limited to, inventory management applications, point-of-service (POS) applications (e.g., for automated ordering and/or payment kiosks), mobile customer ordering applications, order management applications, labor management applications and fleet management applications.

As noted above, in a conventional retail store some form of nominal operational plan may be implemented in a piecemeal fashion for some contingent of available resources. For example, store associates are often scheduled to work on respective overlapping or contiguous shifts on different days to ensure adequate staffing based on empirical observations by management of customer traffic and/or inventory management requirements, for example. Such nominal operational plans tend to be predetermined and/or relatively static for a given day or time period, and may be reiterated wholly or in part with some periodicity. However, if an operational plan needs to be changed, for example, in response to a change in operating conditions (e.g., surges in customer demand, unexpected/unforeseeable inventory issues, associate/staff shortages or unexpected absences, natural phenomena such as storms, etc.), the retail store generally is unable to respond or adapt to the changes in a timely manner, if at all.

The challenges faced by a conventional retail store to readily implement and adjust if necessary a holistic operational plan for the store itself and, in some cases, the greater retail ecosystem in which it operates is due, in part, to the respective resources (e.g., store associates, retail operational subsystems, retail applications) generally being configured to operate as standalone systems or, at best, partially-integrated systems. Said in another way, conventionally speaking, respective retail operational subsystems or retail applications do not necessarily communicate information or data to other retail operational subsystems or retail applications in a cogent manner, if at all, let alone taken together with the coordination of store associates.

In connection with conventional retail operations, the Applicant has recognized and appreciated that diverse information (e.g., data) that may be available from respective retail operational subsystems and/or retail applications is not holistically collected, managed, normalized, or “centrally” stored to permit ready access of the information from which valuable insights may be gained; in particular, there is no centralized database of indexed normalized information germane to the multiple retail operational subsystems and/or retail applications (and the overall effective operation of the store) in a conventional retail environment, and there is no particular controller to utilize such information to facilitate dynamic and holistic operation of the retail store in a coordinated manner, and in response to a wide variety of evolving circumstances.

As a result of the foregoing, if a reallocation of resources in the retail store is needed, a store manager typically is required to manually determine the manner in which the resources should be reallocated, convey this information to one or more store associates, and/or adjust the operation of one or more retail operational subsystems on-the-fly. In one respect, such changes arising from management decision may occur with a relatively longer response time compared to the timescale at which the operating conditions are changing; i.e., meaningful changes in retail operations are effected too slowly and may ultimately have little impact (and/or unintended and undesirable consequences). In another aspect, the store manager may only have at their disposal a relatively limited amount of information associated with the retail operational subsystems, retail applications, and/or changing conditions and may thus adjust the operation of the retail store in a manner that fails to effectively address the change in circumstances evolving in the retail store. Moreover, inevitably a store manager will not make purely objective decisions regarding changes in an operational plan, but rather will likely make such decisions with some degree of bias (e.g., based on past experience and/or various assumptions).

In view of the foregoing challenges of operating a retail store, a retail execution system is disclosed herein, which communicates with multiple retail operational subsystems, multiple retail applications, and one or more data repositories to store data germane to the operational subsystems, the applications, and the retail store itself. In various aspects, the retail execution system accesses data from and facilitates control of the operational subsystems, and further supports one or more retail applications that also provide data relating to the retail store, which may be used by the retail execution system to adjust one or more operational subsystems in an automated manner. Thus, in multiple aspects, the retail execution system facilitates coordinated, dynamic, reliable, efficient, and profitable operation of a retail store.

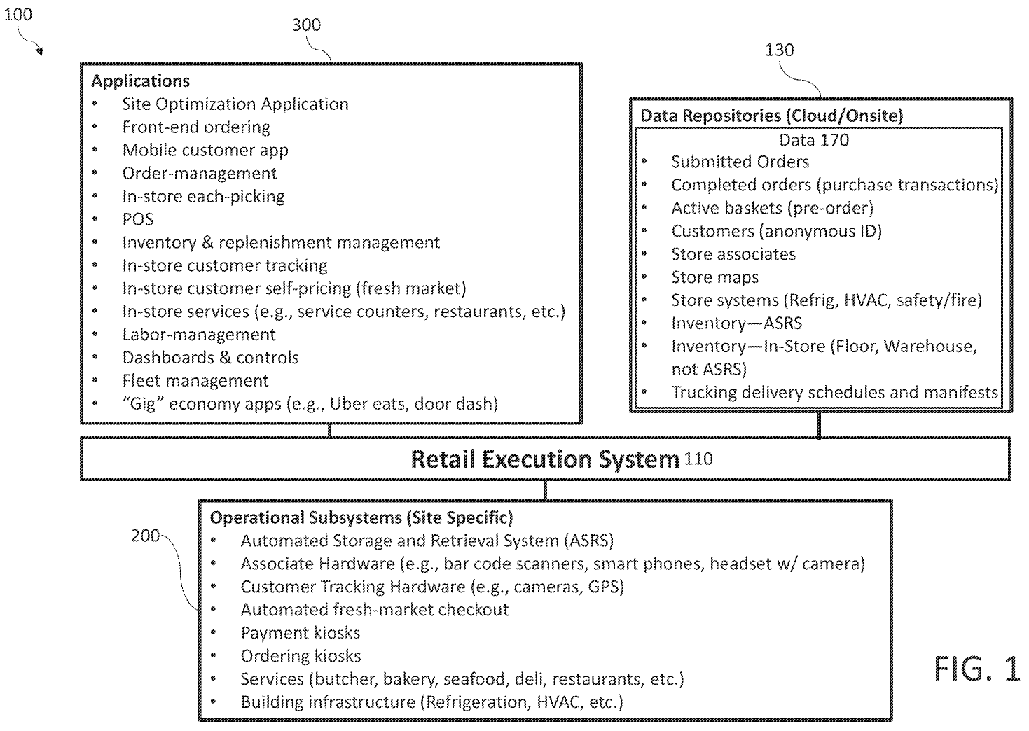

To generally illustrate the inventive concepts associated with a retail execution system as disclosed herein, FIG. 1 illustrates multiple examples of retail applications 300, examples of retail operational subsystems 200, and one or more data repositories 130 to store data 170 comprising multiple retail data type examples associated with a retail facility control system corresponding to one or more retail facilities, such as retail stores 100, fulfillment centers, distribution centers 14, market distribution centers 18 (MDC) and/or other retail facilities (for purposes of the present disclosure, a retail store may also be referred to herein as a “retail site” or a “market”) configured to attempt to optimize operation of one or more retail facilities, in accordance with some embodiments. It should be appreciated that the various examples shown in FIG. 1 of retail applications 300, retail operational subsystems 200, and various data types of the stored data 170 are non-limiting examples and not exhaustive.

FIG. 1 also shows an exemplary retail execution system 110 that interfaces with the various retail applications 300, retail operational subsystems 200, and data repositories 130, and has access to the various data 170, to facilitate overall operation of the retail store 100. More specifically, as discussed in further detail below, the retail execution system 110 can be communicatively coupled to respective retail operational subsystems 200 and retail applications 300, thus allowing data 170 associated with a given operational subsystem and/or application to be acquired and shared with other operational subsystems and/or applications (e.g., without store manager intervention), in some instances to facilitate control of multiple subsystems and applications in a coordinated manner. The one or more data repositories 130 may reside in part locally onsite at or near the store, and/or may be partially, primarily or wholly cloud-based, to provide reliable and intelligible access to, and storage of, a wide variety of data 170 useful to the respective functions and coordination of various applications 300 and/or subsystems 200.

In some implementations, the retail execution system 110 may also provide a foundation upon which applications 300 may be developed to utilize the data 170 to facilitate operation of the retail store 100 and/or upon which existing applications may be integrated. For example, the retail execution system 110 may communicate with and have access to a given retail application that may be associated with one or more of the operational subsystems, another retail application that may be associated with customers (e.g., a mobile customer ordering app), and another retail application that may be associated with a third-party (e.g., an in-store restaurant or service counter, or a “gig economy” app such as Uber Eats or DoorDash). In this manner, the retail execution system 110 allows real-time interoperability across multiple different types of applications 300 and subsystems 200 to support various use cases and/or operational plans within the retail store.

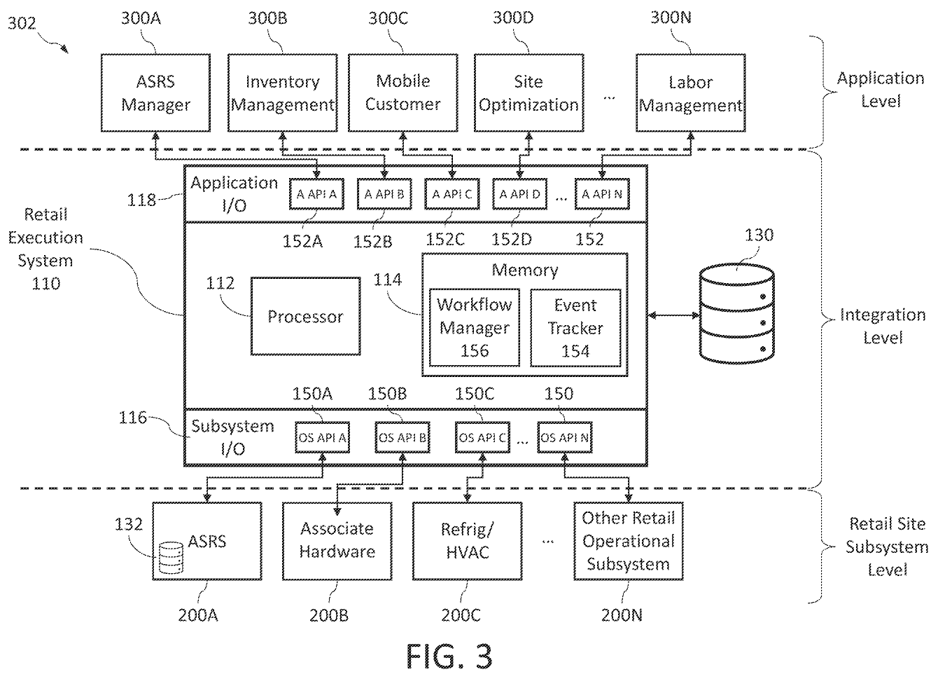

As discussed further below in connection with FIG. 3, in some implementations the retail execution system 110 may implement multiple retail-specific APIs (Application Programming Interfaces) to facilitate access to and communication between the retail applications 300 and the retail operational subsystems 200 across the retail store 100. In one example, respective retail applications 300 and operational subsystems 200 may have access to applicable data 170 in the data repository 130. In another example, the retail execution system 110 may provide standardized messaging where communication between different retail applications 300 and/or retail operational subsystems 200 is desired. The data 170 may generally be formatted in accordance with various standardized data formats including, but not limited to, RESTful services (a Representational State Transfer (REST) format) and a JavaScript Object Notation (JSON) format.

### 1.1 Retail Enterprise Including Retail Stores Having a Retail Execution System

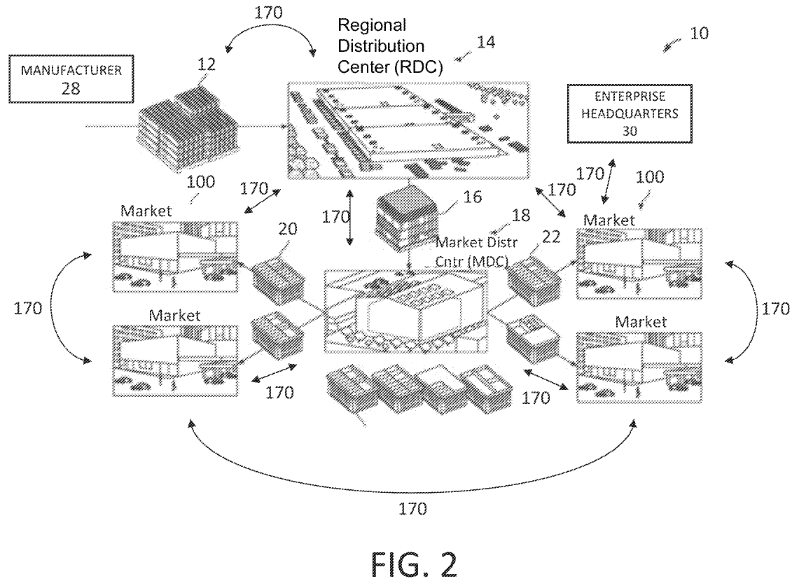

FIG. 2 shows an exemplary retail supply chain 10 (also referred to herein as a “retail enterprise”) that includes multiple retail stores 100 for which operation can be optimized through one more of the retail facility optimization systems, in which data can be shared between at least some of the retail stores, according to the inventive concepts discussed herein. For example, FIG. 2 shows an example retail enterprise 10 and multiple retail stores 100 (“markets”), wherein one or more of the stores 100 may incorporate a retail execution system 110. As shown, the retail enterprise 10 may control the supply chain of goods beginning with one or more manufacturers 28 to the retail stores 100. Palletized cases of goods 12 may be received from the manufacturer(s) 28 at one or more regional distribution centers (RDC) 14. The regional distribution center 14 may thereafter supply palletized mixed cases of goods 16 to one or more market distribution centers (MDC) 18. The MDC 18 may then decant (e.g., remove individual eaches of one goods from packaging) and store eaches of the same product in various sized sub-totes 24. The MDC 18 may thus supply totes containing sub-totes 20 and 22 with mixed eaches to the retail stores 100.

Additionally or alternatively, totes and sub-totes may not be provided for at least some products where cases or other suitable containers may be used. Similarly, shipments may additionally or alternatively be made to the retail stores 100 in totes directly from the distribution center 14 with no market distribution center 18. The function of the regional distribution center 18 and/or market distribution center 14 may be combined into one site for one or more distribution center and market distribution center, and/or for one or more geographic regions. Here, the example regional distribution center 14 and market distribution center 18 offers the capability to store a large selection of goods that a customer may order to be delivered to their retail store 100 on the next replenishment. One or more of such products may not regularly be stored at the retail store 100. The retail store 100 may be a traditional self-service store and/or may have a different format.

As noted above, one example format for the retail store 100 may be a “Micro Fulfillment Center” or “MFC,” in which a self-service store can be combined with automation that allows orders to be fulfilled either in conjunction with or separate from the self-service store. An example of an MFC is disclosed in WIPO International Application No. WO 2021/243059 A1 having publication date Dec. 2, 2021 entitled “High Density Micro Fulfillment Center ‘HD-MFC’ with Nightly G2P Storage Batch Pick Replenishment from Store Floor and Method of Operating Same,” which is hereby incorporated by reference in its entirety.

Another example format may be similar to an MFC, but where non-fungible and fungible goods are substantially separated between the automation and the self-service store, which is herein after referred to as a “Novastore”. An example of such a Novastore is disclosed in U.S. Pat. No. 11,142,402 having issue date Oct. 12, 2021 entitled “Automated Service Retail System and Method” which is hereby incorporated by reference in its entirety.

In the retail enterprise 10, various data 170 may be shared between retail stores 100 and/or between any two of the manufacturer 28, the RDC 14, the MDC 18, the retail stores 100, and/or other sites or centers both physical and/or virtual. The data 170 shared may be used in machine learning to make unpredictable site performance more predictable where machine learning may selectively employ operational data across multiple sites to shorten and improve the learning cycle for a given site.

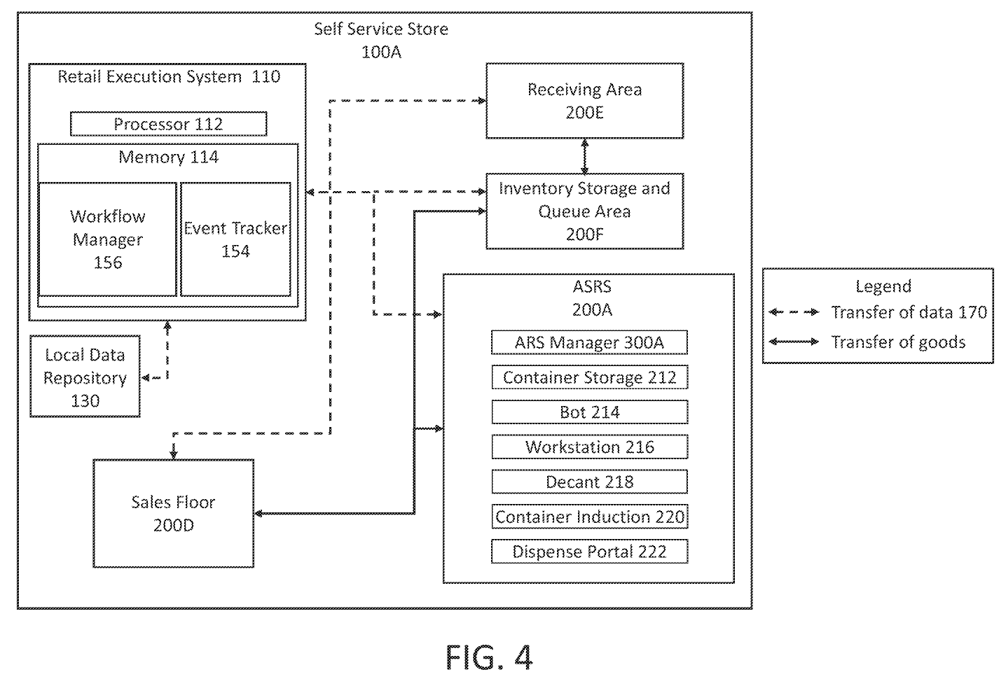

As discussed further below in connection with FIG. 4, in an example implementation one of the retail applications 300 with which the retail execution system 110 may communicate with includes a site optimization application. In one aspect, a site optimization application associated with a given retail store 100 may be configured to adjust the operational plan of the retail store in response to a change in operating conditions and/or an objective specified by a store manager, store associate and/or one or more other entities (e.g., retail chain management, regional manager, other such sources, or a combination of two or more of such sources). The retail execution system 110 and the site optimization application may work together to facilitate operation of the retail store 100 as a fully integrated and highly optimized system, unlike conventional retail stores. As noted above, conventional retail stores typically operate using a collection of separate tools, applications, and physical infrastructure that are then somewhat “integrated,” in a piecemeal fashion, by human users in the service of customers. In contrast, a retail store 100 having a retail execution system as disclosed herein, in some instances together with a site optimization algorithm, operates more as a predictable and optimized machine as opposed to a suboptimal collection of hardware, software, and human elements.

In some implementations, optimization pursuant to a site optimization application may also be extended to the retail enterprise 10 to improve operating efficiency. In one aspect, eaches may be secured in an automated supply chain with full traceability from receiving of pallet from manufacturer at a Regional Distribution Center (RDC) to sale to customer in an order bag or otherwise, for example, as disclosed in U.S. Pat. Publication No. US2018/0247257 entitled “Inventory Management System and Method” published on Aug. 30, 2018, which is hereby incorporated by reference in its entirety.

### 1.2 Example Retail Operational Subsystems

With reference again to FIG. 1, in general a given retail operational subsystem 200 may include hardware and software to control the hardware to perform one or more functions in the retail store 100. The following are non-limiting examples of retail operational subsystems 200 that may be deployed in a given retail store 100. One example of a retail operational subsystem 200 may be an Automated Storage and Retrieval System (ASRS). As would be readily appreciated by one of ordinary skill in the art, an ASRS generally comprises a combination of equipment (hardware) and control methodologies (e.g., implemented by one or more software applications) for automatically storing loads (e.g., parts or items) to, and retrieving loads from, one or more respective storage locations, often as part of a manufacturing or warehousing (e.g., goods and materials distribution) process. In such processes, storage density can often be an important consideration due to space limitations, and also there is often a high volume of loads being moved into and out of storage, for which an ASRS is an effective solution.

The defined storage locations in an ASRS are often within a storage grid, array, matrix, other such configurations or a combination of two or more of such configurations (e.g., a vertical rack structure, a cubicle storage grid). A wide variety of loads and storage grid architectures are contemplated for different ASRSs; examples include loads that may be one thousand pounds or greater stored on pallets within a storage grid reaching one hundred feet or more tall, to significantly lighter loads that may be stored in a given location in a storage grid on a tray or within a bin or container, sometimes also referred to as a “tote.” Various automated transport mechanisms also are contemplated for different ASRS implementations, including for example: vertical lift modules (VLMs) that can vertically transport trays in a column and automatically insert and extract a tray into and out of a designated location in the storage grid; various types of shuttles (e.g., mobile robots) for automated handling and transport of trays or containers (e.g., totes) to and from their defined storage locations in the storage grid; conveyor and/or gantry systems on which loads are transported; and non-stationary storage grids including horizontal and/or vertical carousels.

In a conventional ASRS, one or more computing devices and one or more software applications executing on the computing device(s) implement various functionality within the ASRS, including maintaining an inventory of items stored in the ASRS. Retrieval of items from defined storage locations can be accomplished by specifying (e.g., to the appropriate software application in the ASRS) the item type and quantity to be retrieved, and the application determines where in the storage area the item can be retrieved from and instructs and/or schedules the retrieval. In one example, an appropriate transport machine (e.g., mobile robot) may be directed to the location where the item is stored and then directed to deposit the item at a location where it is to be picked up. In some ASRSs, as noted above, a system of conveyors and/or automated transport vehicles can be employed to transport loads into and out of the storage area and move them to a manufacturing floor or loading dock, for example. To store items, the pallet or tray can be placed at an input station for the system, the information for inventory can be entered into an inventory database and/or other computer memory. The entry of the information may be based on an automated process as the one or more items are received at the facility and/or moved through the facility (e.g., barcode scanners, QR code scanners, RFID tag readers, image capture and processing systems, text recognition processing, other such systems and methods of obtaining item information, or a combination of two or more of such information obtaining systems), manual entry system (e.g., workers enter information through one or more computer terminals, etc.), other such systems, or a combination of two or more of such systems. In some embodiments, the ASRS system can move the load to the storage area, determines a suitable location for the item, and stores the load in one or more storage locations. As items are stored into or retrieved from the racks, the an ASRS inventory control computer, server and/or processors updates its inventory accordingly. Some of the benefits of an ASRS include, but are not limited to, increased data collection (e.g., from sensors and other automated equipment) which in turn fosters greater visibility into inventory-related operations, reduced labor for transporting items into and out of inventory, reduced inventory levels, more accurate tracking of inventory, and space savings.

In one implementation germane to a retail store, an ASRS also may be referred to as a “goods-to-person” (G2P) system that stores inventory and utilizes automation to sequentially bring goods to a picker and compile customer orders using the picker to pick goods. In some examples, the ASRS may utilize one or more mobile robots to facilitate automated fulfillment operations for the fulfillment of orders (e.g., by bringing goods to a picker at a workstation). The picker may be a human associate, an automated picking system, or combination thereof. In some examples, the fulfillment system may utilize one or more store associates to manually fulfill orders and/or transport compiled orders to customers. In some implementations, the fulfillment system may utilize a combination of robots and store associates to fulfill orders.

In another example, the operational subsystem 200 may be an automated fresh-market checkout. The automated checkout generally includes hardware to facilitate payment of goods picked by a customer in the retail store 100. The automated checkout may provide one or more physical or virtual location(s) where goods picked by a customer are tallied and paid for.

In another example, the operational subsystem 200 may be one or more payment kiosks located in or near the retail store 100 where customers pay for a given order.

In another example, the operational subsystem 200 may be one or more ordering kiosks located in the retail store 100, near the retail store 100, or at an off-site location where customers may create a given order to be fulfilled.

In another example, the operational subsystem 200 may include various hardware to facilitate operation of staffed services within a retail store including, but not limited to, a butcher, bakery, seafood, deli, and a restaurant. At these locations, store associates and/or robots may be used to provide a product to a customer.

In another example, the operational subsystem 200 may be building infrastructure and/or systems utilized within the building including, but not limited to, refrigeration, heat, ventilation, and air conditioning (HVAC), fire protection systems, security and access systems, and power management systems.

In another example, the operational subsystem 200 may include hardware used by store associates to interface with the retail execution system 110 and/or to communicate with other store associates. The hardware may include, but is not limited to, handheld wearable devices, a headset with a camera, an audio device (e.g., a speaker), a cell phone, and a scanning device (e.g., a bar code scanner).

### 1.3 Example Retail Applications

With reference again to FIG. 1, the retail applications 300 may include a broad array of site-specific and enterprise applications where the retail execution system 110 is configurable based on the retail business. For example, a large retailer may manage orders and inventory centrally in an enterprise deployment of one or more retail execution systems 110 (see the exemplary retail enterprise 10 of FIG. 2) whereas specific retail sites of the large retailer may additionally or alternatively manage picking and fulfillment locally in a site-specific deployment of a retail execution system 110, which may utilize information and/or instructions received from a central system as well as local information obtained from one or more operational subsystems 200, sensors, customer devices, other such sources, or combination of two or more of such sources. Accordingly, the retail execution system 110 provides standard interfaces for a host of applications. The following are non-limiting examples of retail applications 300 as well as templates upon which to build or interface with new applications or services.

In one example, one of the retail applications 300 may be a site optimization application. The site optimization application may access data associated with other applications 300 and/or operational subsystems 200 to modify and adjust an operational plan to meet defined business priorities and/or operational goals. In some implementations, the site optimization application may be used to improve operation of a specific retail store 100 or, more broadly, operation of two or more retail stores, a supply chain in the retail enterprise 10, and the like. The site optimization application may leverage data from other sites to improve cycles of learning utilizing machine learning and/or artificial intelligence (AI) elements. It should be appreciated that although a site optimization application may be one of the retail applications 300 with which the retail execution system 110 may communicate, in other implementations a site optimization algorithm may be implemented in a retail store (or in multiple retail stores across an enterprise) without necessarily requiring a retail execution system. See, for example, the site optimization application 410B disclosed in sections 2.4 and for further details.

In another example, one of the retail applications 300 may be a front-end ordering application, which provides an environment, accessible through an electronic device (e.g., computer, smartphone, tablet, laptop, wearable device, etc.), where customers can search for products and be exposed to the inventory across a retail enterprise or the inventory at one or more local sites depending, in part, on the desired mode of acquiring the items (e.g., delivery time and manner of delivery, pick-up location, pick-up time, etc.). This front-end order application can further allow the customers to select products, manner of delivery or other such acquisition, place orders for the selected products, provide payment and/or other such functionality. Customers may further modify orders, cancel orders, and/or arrange for returns. Data generated by a front-end ordering application and that may be collected by the retail execution system 110 is generally referred to herein as “front-end ordering customer data.”

In another example, one of the retail applications 300 may be a mobile customer application, which provides an environment, accessible through a mobile electronic device (e.g., smartphone, tablet, laptop, wearable device, etc.), where customers can select and purchase products in the same manner as the front-end ordering application with the difference being the customer may also be notified via text or otherwise of order status, pick up location, and/or shipping status. The mobile customer applications may also provide a global positioning satellite (GPS) location of the customer and allowing geofencing. See, for example, the exemplary mobile customer application 300C in FIG. 3. Data generated by a mobile customer application and that may be collected by the retail execution system 110 is generally referred to herein as “mobile customer data.”

In another example, one of the retail applications 300 may be an order-management application, which provides an environment where the order fulfillment process and/or operation can be managed. For example, an order may be received and the method of fulfillment of the order can be defined based on one or more constraints associated with the order. The constraints may include, but are not limited to, inventory position by location, time allocated to fulfill, method to fulfill (pick up, delivery etc.), and shipping and delivery preferences. Data generated by an order-management application and that may be collected by the retail execution system 110 is generally referred to herein as “order-management data.”

In another example, one of the retail applications 300 may be a return-management application, which provides an environment where returns are managed. For example, a return request may be received and the method of return and disposition of the given return managed. The return request may be accepted or rejected, for example, on items that are not returnable. The method of return may be via shipping or local site drop off at kiosk or otherwise. Further, the application may also manage the disposition of a returned item, for example, by introducing the returned item back into new inventory, sending the item for reconditioning, and/or disposing the item.

In another example, one of the retail applications 300 may be an in-store each-picking application, which provides an environment where in-store picking can be managed. The in-store picking may be by store associates that pick items from a sales floor, store associates that pick items from a warehouse, or automated each picking via an ASRS. For example, the in-store each-picking application may manage manual picks in the store (e.g., directing a store associate to locations on the sales floor where items in an order are located) and the process of order induction into an ASRS for fulfillment. The in-store each-picking application may further include management of order storage for pick up (by a customer) or for further consolidation with other items. Data generated by an in-store each-picking application and that may be collected by the retail execution system 110 is generally referred to herein as “in-store each-picking data.”

In another example, one of the retail applications 300 may be a point of sale (POS) application, where a point of sale (POS) application processes a set of items in an order by applying pricing data and business rules to calculate and present the price to be charged to the customer, calls a payment application to conduct the tender transaction, and provides a receipt to the customer. The pricing functionality of the POS is typically used in conjunction with a front-end online ordering application, and with in-store self-checkout applications. A POS application may provide an environment where data regarding products or product attributes is exposed to customers and store associates in a retail site setting to efficiently perform transactions. The POS application may have similar attributes to the front-end ordering application where the former can be for the retail store 100 and the latter can be for E-commerce applications. The POS application may provide an environment where the consumer leaves the site and/or pays for merchandise. Data generated by a POS application and that may be collected by the retail execution system 110 is generally referred to herein as “POS data.”

In another example, one of the retail applications 300 may be an inventory & replenishment management application (or more simply “inventory management application”), which manages inventory levels and provides for inventory replenishment at a given site or a given retail enterprise. In one aspect, the inventory & replenishment management application compares inventory levels with orders and determine what replenishment is required by site within the constraints of supply chain capacity and product availability. Data generated by an inventory and replenishment management application and that may be collected by the retail execution system 110 is generally referred to herein as “inventory management data.”

In another example, one of the retail applications 300 may be an in-store customer self-pricing application (e.g., for a fresh market), which provides an environment where a customer can select goods that are not priced individually, but rather by weight or quantity such as produce. The customer may select one or more items, identify and weigh the items, and package the items via some indicia based on the contents, weight and/or price using a bar code or otherwise. Data generated by an in-store customer self-pricing application and that may be collected by the retail execution system 110 is generally referred to herein as “self-pricing data.”

In another example, one of the retail applications 300 may be an in-store services application, which provides an environment where in-store services are managed. Examples of in-store services include, but are not limited to, service counters and restaurants.

In another example, one of the retail applications 300 may be a labor-management application, which provides an environment where employees (e.g., store associates), contractors, and other resources are managed. The labor-management application may monitor different aspects of the employee-employer relationship including, but not limited to, performance management, training and proficiency management, scheduling of a given associate, location of a given associate in the store when the associate is on shift (e.g., via GPS on smart phones, cameras disposed in the store, RFID tagging, etc.), data from any equipment (e.g., scanners, bar code readers, cameras) used by the employee/store associate, contractor or other resource, and overall attendance and punctuality. Data generated by a labor management application and that may be collected by the retail execution system 110 is generally referred to herein as “labor management data.”

In another example, one of the retail applications 300 may be a dashboards & controls application, which provides an environment where data may be visualized and connected. The dashboards may be configured around business metrics, such as profitability over time or capital efficiency, and may be deployed at the retail store or retail enterprise level. The dashboards may also be configured around operational metrics such as schedules, inventory position, order volumes or otherwise. The dashboards may further be configured around employee metrics such as safety incidents, training status or otherwise. As such, the dashboard application may be configured to display any aspect of the retail store 100 and/or retail enterprise 10 and utilize the data 170 to expose status and trends.

As noted above, applications 300 may be developed to facilitate operation at the retail store level or at the retail enterprise level. The following is a table that lists a non-limiting example allocation of the above applications 300 for retail store level and enterprise level deployment.

| | | |
|---|---|---|
| Application | Enterprise | Retail Store |
| Front-end ordering | X | |
| Mobile customer app | X | |
| Order management | X | X |
| In-store picking | | X |
| POS | | X |
| Inventory management | X | |
| In-store pricing | | X |
| In-store services | | X |
| Labor management | X | X |
| Dashboards & controls | X | X |
| Optimization | X | X |

### 1.4 Example Data

The data repository 130 may provide common storage for different types of data, thus reducing the need for duplicate or distributed data across multiple devices and/or systems in the retail store 100. Other embodiments, however, provide for distributed storage to improve data traffic, provide redundancy, improve access, reduce access times, reduce or prevent loss, and other such benefits. The data 170 stored in the data repository 130 may include a default set of fields representing a given data attribute. In one aspect, different categories or classes of data may be established with particular hierarchies; for example, in one implementation, data aggregated from a variety of retail applications and/or retail operational subsystems may be first categorized at a relatively higher level according to “customer-related data,” “associate-related data,” and “store-related data,” and then each of these first data categories may be further divided into multiple subcategories. For purposes of illustration, an example of a further categorization of “customer-related data” can include, but is not limited to: front-end ordering customer data; mobile customer data; completed order data; pre-order data; customer anonymous ID data; POS data; self-pricing data. Similarly, an example of a further categorization of “store-related data” includes, but is not limited to: items/goods data; order-management data; in-store each-picking data; inventory management data (e.g., for store inventory that is not in an ASRS); ASRS data (which may include ASRS inventory data as opposed to inventory in other portions of the store, as well as other ASRS-specific data relating to functional subsystems such as mobile transport/bots, picking workstations, dispense portals, etc.); store map data; delivery data (e.g., trucking delivery schedules and manifests); store systems data (e.g., refrigeration, HVAC, safety/fire). Likewise, an example of a further categorization of “associate-related data” includes, but is not limited to: labor management data; employee HR data.

The following are non-limiting examples of data 170 and their attributes.

In one example, the data 170 may be on submitted orders (“front-end ordering data”) with attributes that include, but are not limited to, customer identification, product(s) and quantities, date of order, price paid, discounts, target method of fulfillment, and target time to fulfillment.

In another example, the data 170 may be on completed orders (“completed order data”) with attributes that include, but are not limited to, customer identification, product(s) and quantities actually delivered, substitutions, actual method of fulfillment, and actual time to fulfillment.

In another example, the data 170 may be on active baskets (“pre-order data”) with attributes that include, but are not limited to, product(s) and quantities placed in a customer basket, product(s) and quantities removed from a customer basket site browsing history, and site search history.

In another example, the data 170 may be on customers (“customer anonymous ID data”) with attributes that include, but are not limited to, attribute data such as age, gender, ethnicity, income level, number of other people in household, typical basket size, purchasing habits and history, punctuality, and likeliness of changing order contents.

In another example, the data 170 may be human resources-related data on store employees (e.g., “employee HR data”) with attributes that include, but are not limited to, name, age, gender, training certifications, length of service, and employment history.

In another example, the data 170 may be on item/goods (“items/goods data”) with attributes that include, but are not limited to, stock-keeping unit (SKU) data, product data, item weight, item packaging data, item size, item cold-chain requirements and environmental constraints (chilled, frozen, ambient, max storage temperature), item return rules, expiration date, handling restrictions, automation features and restrictions, and warranty data.

In another example, the data 170 may be on store maps (“store map data”) with attributes that include, but are not limited to, floor space layouts, environmental zones, aisle content data, chilled and frozen locations, warehouse and retail space zones, employee and customer zones, HVAC and chiller locations, plumbing locations, parking and site layouts, and surrounding area data.

In another example, the data 170 may be related to the ASRS (“ASRS data”) with attributes that include, but are not limited to, data associated with the goods to person picking system such as storage locations and contents of storage locations, stored order locations and available for picking storage locations, work in process (not in storage) and location, inventory content and location by environmental zone (ASRS inventory data), picked inventory not yet in an automated storage and retrieval system (ASRS), expiration data, and other item data as applied to inventory in the ASRS.

In another example, the data 170 may be on in-store inventory (inventory management data) with attributes that include, but are not limited to, storage locations and contents of storage locations in a warehouse or a store floor, stored order locations and available for picking storage locations, work in process (not in storage) and location, inventory content and location by environmental zone, expiration data, and other item data as applied to inventory in the locations other than the ASRS.

### 2. Example Implementations of a Retail Store

### 2.1 Retail Execution System Details

FIG. 3 is a block diagram of an exemplary retail facility control system 302, in accordance with some embodiments, that includes an exemplary retail execution system 110 of FIG. 1 with additional details showing input/output (I/O) interfaces between example retail applications 300 and example retail operational subsystems 200 as well as internal functional components of the controller, in accordance with some embodiments.

In FIG. 3, the general environment in which the retail execution system 110 can operate is depicted for purposes of the present discussion as including exemplary three “levels;” namely, an “application level” at the top of FIG. 3 that shows respective specific examples of retail applications 300A, 300B, 300C...300N, a “retail site subsystem level” at the bottom of FIG. 3 that shows respective specific examples of retail operational subsystems 200A, 200B, 200C...200N, and an “integration level” in the middle of FIG. 3 that shows an exemplary retail execution system 110 and one or more exemplary data repositories 130. For simplicity of illustration, only some of the possible retail operational subsystems 200 and retail applications 300 shown in FIG. 1 are shown in FIG. 3. In particular, examples of specific retail applications in the exemplary application level of FIG. 3 include, but are not limited to, an Automated Storage and Retrieval System (ASRS) manager 300A, an inventory management application 300B, a mobile customer application 300C, a site optimization application 300D, and a labor management application 300N. Similarly, examples of specific retail operational subsystems in the exemplary retail site subsystem level of FIG. 3 include, but are not limited to, an ASRS 200A, associate hardware 200B, and refrigeration/HVAC systems 200C.

In one salient aspect according to the inventive concepts disclosed herein, the retail execution system 110 uniquely integrates respective diverse retail applications 300 and retail operational subsystems 200 to facilitate the aggregation of “customer-related data,” “associate-related data,” and “store-related data,” which aggregated data in turn may be used to more effectively control the operation of one or more operational subsystems in the retail store (e.g., in particular, the ASRS 200A) and more generally the retail store overall. As noted above in connection with FIG. 2, the data aggregation facilitated by the retail execution system 110 may be employed at the enterprise level as well to aggregate data from multiple retail stores, as well as from one or more regional distribution centers and one or more market distribution centers, to facilitate improved operations throughout the retail enterprise 10.

As discussed above in connection with FIG. 1, the one or more data repositories 130 shown in the integration level of FIG. 3 may be local memory storage devices at the retail store, cloud-based data repositories, or a combination of local and cloud-bases storage. Furthermore, it should be appreciated that one or more of the applications and/or operational subsystems 200 may themselves be associated with some form of memory storage (e.g., see data repository 132 in the ASRS 200A). In one aspect, the retail execution system 110 facilitates data transfer between the one or more data repositories 130 and one or more other data repositories associated with one or more of the retail applications and retail operational subsystems to provide for common availability of relevant data throughout the retail store environment.

To facilitate communicative coupling between the respective levels shown in FIG. 3, the retail execution system 110 can include one or more processors 112, one or more memories 114, multiple application input/output (I/O) interfaces 118 to communicate with the retail applications 300 and multiple subsystem I/O interfaces 116 to communicate with the retail operational subsystems 200. It is noted that the processor 112 may also be referred to as a control circuit and is configured, for example by using corresponding programming, to carry out one or more of the steps, actions, and/or functions described herein. Such a processor or control circuit, for example, may comprise a fixed-purpose hard-wired hardware platform including but not limited to an application-specific integrated circuit (ASIC), a field-programmable gate array (FPGA), and the like or comprise a partially or wholly programmable hardware platform including but not limited to processors, microcontrollers, microprocessors, and the like. The ASIC may be an integrated circuit that is customized by design for a particular use, rather than intended for general-purpose use. More specifically, in FIG. 3, the multiple application I/O interfaces 118 may include respective “application programming interfaces” (APIs) 152 (e.g., one for each retail application) and the multiple subsystem I/O interfaces 116 may include respective APIs 150 (e.g., one for each retail operational subsystem). As would be readily appreciated by one of skill in the art, an “application programming interface” (API) is a piece of software that defines how instructions and data (e.g., requests and responses) are communicated between a given retail application or a given retail operational subsystem and the retail execution system 110. A given API can define the types of requests that can be made, how to make them, and the data format to be used. Stated alternatively, a given API may be a connection between respective computers or between computer programs operating on the same or different computers where API may refer to a software interface that offers a service to other pieces of software.

The retail execution system 110 shown in FIG. 3 can also include an event tracker 154 (e.g., a software module residing in the memory 114) that manages and tracks events occurring in the application level or the retail site subsystem level. For purposes of the present discussion, an “event” is some action recognized by the event tracker 154 based on data that is received by the retail execution system 110 from one or more applications 300 or operational subsystems 200. A non-limiting example of an event may be an “order placed” event that occurs when a customer places an order with the POS application of the retail applications 300. The “order placed” event may be captured by the POS application and reported to the retail execution system 110 over a POS application API of the retail APIs 152 and then tracked by event tracker 154; upon detecting such an event, the event tracker may then make a request to the POS application, via the POS application API, for data associated with the order. The event tracker 154 may then log the event and associated data in the one or more data repositories 130.

The exemplary retail execution system 110 shown in FIG. 3 can also include a workflow manager 156 (e.g., a software module residing the memory 114) that is configured to instruct or control one or more applications and/or operational subsystems to take one or more actions based on one or more events tracked by the event tracker 154. In one aspect, the workflow manager 156 functions to significantly automate flows of work in the retail environment. For example, in response to the “order placed” event discussed above, the workflow manager 156 may trigger a pick operation by communicating with a store associate via associate hardware 200B to provide instructions to the store associate, and/or communicating with the ASRS 200A to initiate retrieval of certain ordered goods; the workflow manager 156 may further communicate with the mobile customer app 300C to send an order acknowledgement message and/or other messages (e.g., order complete, item unavailable, etc.).

In various aspects, the workflow manager 156 may be configured with a default set of workflows and also provide a framework for the development of custom workflows. By way of non-limiting example, a promotional message is desired to be sent to the customer upon placement of an order for a certain class of goods via the POS application; however the POS application may not conventionally support this functionality. In this instance, a developer may configure the workflow manager 156, upon receipt of an “order placed” event, with logic to recognize whether the order was for a certain class of goods and if so to send the appropriate promotional message to the customer via the mobile customer application 300C (instead of via the POS application of the retail applications 300).

Following below are some illustrative non-limiting examples of how the retail execution system 110 interacts with one or more retail operational subsystems 200 and/or one or more retail applications 300.

Store associates of the retail store may interact with retail execution system 110 via a labor management application 300N using a variety of devices (e.g., headset, cellular device or local workstation, generally referred to herein as “associate hardware” that constitutes an operational subsystem 200B). Upon starting a given workday, a given store associate may “clock in” to the labor management application where an event of “clocking in” for the employee can be tracked by the event tracker 154 via data received from the labor management application via the corresponding API of the retail execution system. The workflow manager 156 may respond to the tracked event by logging various data such as employee ID and clock-in time to data repository 130.

In the scenario above, the workflow manager 156 may further push the availability of the store associate to site optimization application 300D which in turn may factor the store associate’s availability into the site’s operational plan. Based on business priorities established by site managers, site optimization application 300D may determine that the optimum use of the employee is a schedule of tasks that may include items such as: 1) floor picking and inventory replenishment, and 2) ASRS picking, inventory management and order fulfillment and trigger an event related to the employee schedule being available. The data associated with the schedule of tasks can be taken from site optimization application 300D via the corresponding API 152B of the retail execution system and pushed to multiple other retail applications and data repository 130. For example, the employee may be notified of the day’s schedule via the labor management application and proceed to execute per the schedule. The employee’s geolocation may be tracked by the labor management application and pushed back to the retail execution system 110 at regular intervals for tracking and use with other applications, for example site optimization application 300D. Based on the schedule, the employee may be assigned by way of example to a particular retail operational subsystem 200 such as the ASRS 200A where the employee may interact with different aspects of the picking system where data associated with operations such as picking can be tracked by the retail execution system 110 (e.g., via the corresponding API 150A-150C). Examples here may be updating inventory status of picked items to an inventory replenishment and management application as well as site optimization application 300D. In one aspect, site optimization application 300D is periodically optimizing and updating the operational plan based on actual events that occur during the workday. One example may be to deploy additional picking resources should the employee fall behind by trading off other employee tasks with the needed picking task to meet business priorities, for example customer delivery timeliness or otherwise.

As will be discussed in greater detail below in connection with FIG. 4, various constituent elements of the ASRS retail operational subsystem 200A shown in FIG. 3 may interact with the retail execution system 110 via the corresponding API 150A. Examples of such constituent elements include, but are not limited to mobile robots 214. In one example, some communications to and from the ASRS operational subsystem 200A and some higher level functionality of the ASRS may be managed by ASRS Manager 300A serving as an example retail application, and the retail execution system 110 may communicate with the ASRS Manager via an API 152A. Thus, it should be appreciated that some component of the ASRS (e.g., the ASRS Manager) may interface with the retail execution system 110 via a first API whereas one or more other components of the ASRS may interface with the retail execution system via one or more other APIs.

In some implementations, the ASRS Manager 300A may also be referred to as a material control system (MCS). The ASRS Manager/MCS may manage and pass data to the retail execution system, examples of which include but are not limited to the location of one or more mobile robots, the location of one or more totes, and various inventory within the ASRS 200A. The retail execution system 110 may store any of this data in the data repository 130 or otherwise act on the data pursuant to the workflow manager 156. For example, as mobile robots transfer totes within ASRS 200A, the data associated with the mobile robot activities can be tracked. As customer orders are compiled, the status of a given order in ASRS 200A may be passed back to an order management application via appropriate APIs of the retail site execution system and/or controller 110 and, in some instances, also for use as updated state data for site optimization application 300D. The data may be used for example, if one or more mobile robots fail, the current number of active mobile robots within ASRS 200A may be passed by workflow manager 156 to site optimization application 300D and used as a new constraint reflecting the dynamic nature of the operation. Here, site optimization application 300D may cause ASRS 200A to redeploy mobile robots that previously were not assigned to picking operations in order to satisfy and meet business priorities, for example customer delivery timeliness.

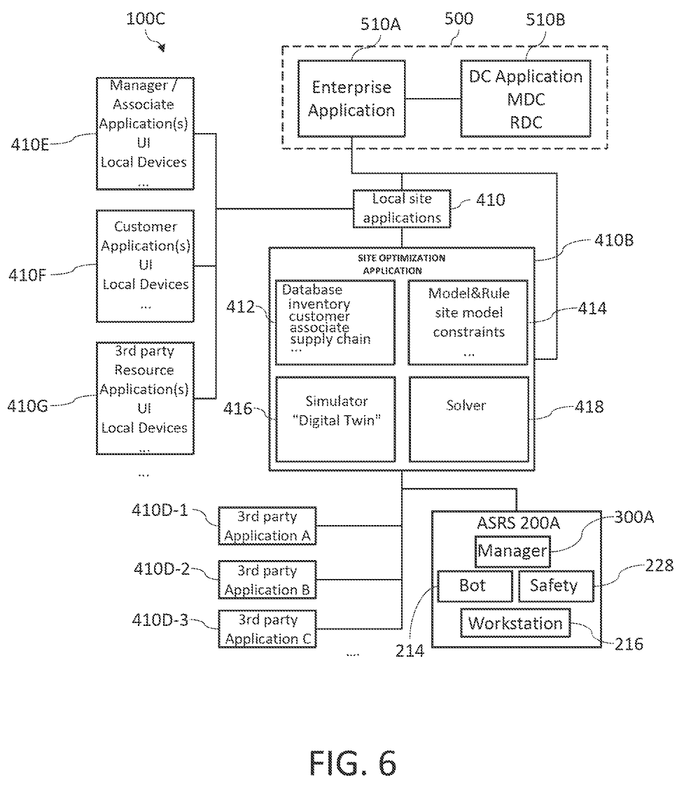

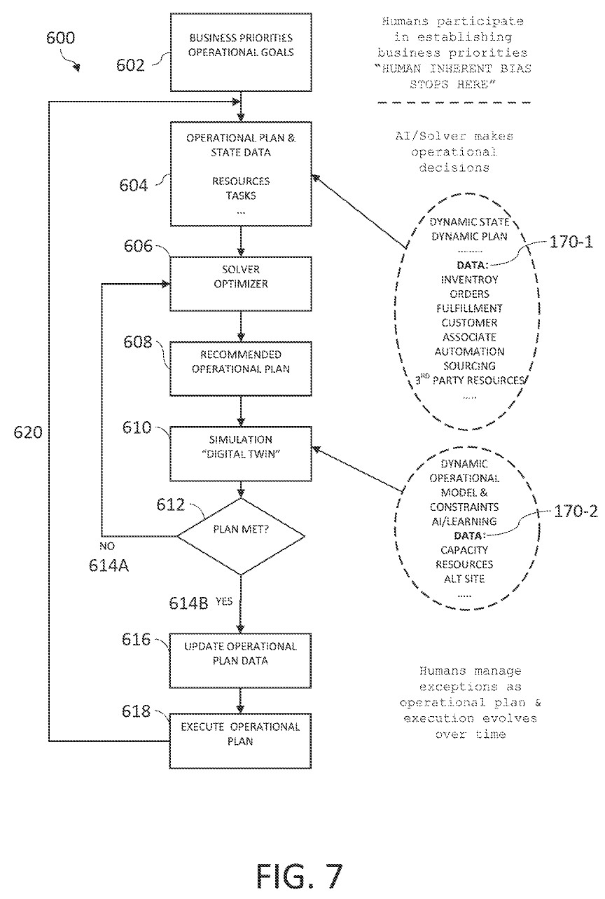

Regarding the site optimization application 300D shown in FIG. 3, additional details of this application are discussed further below in connection with FIGS. 6 and 7. As illustrated in FIG. 3, the site optimization application 300D interfaces with the retail execution system 110 via a corresponding API 152D. In alternate implementations, site optimization application 300D may instead be configured as a component of the retail execution system 110 itself (e.g., as one or more software modules residing in the memory 114 along with the workflow manager 156 and the event tracker 154), or be employed in retail environments that do not necessarily include a retail execution system as described herein.

### 2.2 An Example Hybrid Retail Store With a Retail Execution System

FIG. 4 is a block diagram of an example hybrid retail store 100A that includes a sales floor 200D to facilitate in-store purchases of products in accordance with a “self-serve” model and the ASRS 200A to facilitate, in part, fulfillment of orders placed online in accordance with an “E-commerce” model and/or via an on-site ordering kiosk in the store 100A (e.g., on the sales floor 200D). A retail execution system 110 can also be included to facilitate integration of the various operational subsystems in the store 100A.

For the “E-commerce” option, customers may select goods through a software application installed on a computing device, such as a desktop computer, a cellular device, or a smartphone, which allows the customer to select goods to be fulfilled by the retail store 100A using inventory picked from the sales floor area 200D and/or the ASRS 200A. As shown, the retail store 100A may further include a receiving area 200E to facilitate the intake and unloading of products into the retail store 100A (e.g., from a distribution center) and an inventory storage and queue area 200F to stage products for transport to the sales floor area 200D and/or the ASRS 200A. For example, FIG. 4 shows black arrows to indicate the pathways along which products may move within the store 100A.

Generally, products may be delivered to the retail store 100A and unloaded at the receiving area 200E. The products may be received prepackaged in cases and disposed on pallets. Each of the pallets may have multiple cases of the same product disposed thereon or may have mixed cases of different products disposed thereon. For the “E-commerce” option, the products selected and ordered by a customer may be picked and compiled by an associate and/or a bot instead of the customer picking the products themselves. The picked products may then be consolidated and placed in the store 100A for pickup or delivered directly to the customer.

In some implementations, the ASRS 200A may utilize standardized containers to transport products of varying shapes and/or sizes within the ASRS 200A. For example, the ASRS 200A may include one or more totes to contain one or more products where the products may be same product or different products. In some implementations, at least some of the totes may each include one or more sub-totes, which are smaller totes, dividers, or compartments within the tote used to separate goods of the same or different SKUs within a tote.

The ASRS 200A may include various components and systems to automate the storage of products, the picking of products for customer orders, and the dispensing of orders to customers using the totes and/or sub-totes to facilitate the transport of the products. For example, the ASRS 200A includes container storage 212, which may be one or more multi-level rack structures configured to store product inventory by providing a structure to accommodate one or more totes. The ASRS 200A also includes one or more workstations 216 to pick (e.g., transfer) products from one tote to another tote, bag, box, etc. For example, the workstations 216 may be used to pick an order, e.g., by transferring products from a tote containing product stock to another tote containing products for the customer’s order. In some implementations, the workstations 216 may be manned by one or more associates and/or a robotic picker may be deployed to transfer products between totes. The ASRS 200A can also include one or more dispense portals 222 to discharge orders to customers (e.g., for pickup at the store 100A or delivery directly to the customer). The ASRS 200A can further include one or more robots 214 (also referred to herein as “bots 214”) to facilitate the transport of the totes to and from the container storage 212, the workstations 216, and/or the dispense portals 222. The ASRS 200A may additionally include a decant module 218 to facilitate the addition of products into the ASRS 200A, such as from the inventory storage and queue area 200F. The ASRS 200A may also include a container induction module 220 to facilitate the addition (or removal) of totes from within the ASRS 200A.

As noted above, the ASRS 200A may also include an ASRS Manager 300A (also referred to as a material control system or MCS), which manages the operation of the ASRS 200A. For example, the ASRS Manager 300A may perform one or more of the following non-limiting functions: (1) control and coordinate the transport of the totes within the ASRS 200A, the timing and sequence of totes containing customer orders to be dispensed at the dispense portals 222, (2) assign particular workstations 216 to fulfill a particular order, (3) provide instructions to a store associate or a robotic picker which products to pick for an order, and/or (4) manage and track the stock of products in the container storage 212. In this manner, the ASRS Manager 300A may generally allow the ASRS 200A to operate as a standalone operational subsystem. The ASRS Manager 300A may include one or more computing devices with communications components and software separate from the retail execution system 110.

An example of such a ASRS 200A is disclosed in U.S Pat. No. 11,142,398 having issue date Oct. 12, 2021 entitled “Order Fulfillment System” which is hereby incorporated by reference in its entirety. More generally, any suitable ASRS or each picking system may be provided.

For purposes of this disclosure, the sales floor 200D, the receiving area 200E, and the inventory storage and queue area 200F may each function as a separate retail operational subsystem 200 and/or incorporate elements associated with one or more operational subsystems 200. For example, the sales floor 200D may include various hardware and/or software to facilitate restocking of products, in-store payment of products, and/or the purchase of products from other portions of the store 100A (e.g., placing an order for fungible goods stored in the ASRS 200A). The receiving area 200E may include various hardware and/or software to facilitate the breakdown and separation of products from their respective cases and/or other packaging. The inventory storage and queue area 200F may further include various hardware and/or software to facilitate the intake of data associated with the products inducted into the store 100A (e.g., by using a barcode to scan and read in data).

In another example, each associate may have associate hardware 200B, as described above, to provide instructions to the associate related to one or more tasks and/or to facilitate communication with other store associates. The associates may generally be deployed in different areas of the store 100A, including the ASRS 200A, the sales floor 200D, the receiving area 200E, and/or the inventory storage and queue area 200F; hence, the associate hardware 200B may include some elements that are operably coupled to the ASRS 200A, the sales floor 200D, the receiving area 200E, and/or the inventory storage and queue area 200F. In yet another example, the sales floor area 200D and/or the ASRS 200A may each include one or more payment kiosk subsystem.

FIG. 4 further shows the retail execution system 110 communicatively and operably couples together the ASRS 200A, the sales floor 200D, the receiving area 200E, and the inventory storage and queue area 200F (see dashed black arrows in FIG. 4). In this manner, the retail execution system 110 integrates together operational subsystems that previously relied upon store associates for coordination of respective tasks at each operational subsystem. As described above, the retail execution system 110 may receive data associated with each of the operational subsystems of the store 100A in a centralized manner (e.g., via the event tracker 154).

Compared to conventional retail stores, the data acquired by the retail execution system 110 can provide a more complete assessment on the operation of the retail store 100 at any given moment in time. This, in turn, allows the retail execution system 110 to more effectively manage and control the operation of the retail store 100A particularly when responding to unforeseen changes in operating conditions. The retail execution system 110 may further support one or more retail applications 300 that utilize the data (and/or generate additional data) to facilitate operation of the store 100A. For example, an application 300 may adjust the operation of one or more of the operational subsystems by sending a command or instruction to the operational subsystem via the workflow manager 156.

The data may be stored in one or more data repositories 130 located on-site (or off-site) for later retrieval. However, it should be appreciated the data acquired from the operational subsystems may also be stored in the memory 114 of the retail execution system 110 and/or local memory in the hardware associated with each operational subsystem. The data may include, for example, site information data for each of the products in the whole inventory of the retail store 100A. Other site data may be maintained, such as supply chain, inventory, system, consumers, store employee, management or any suitable data associated with the site. The data repository 130 may store other site information, such as scheduled pickup times, pending customer orders, historical sales data, current and seasonal velocity or other attributes associated with each product sold in or fulfilled from the retail store 100A.

The retail execution system 110 may generally be comprised of one or more computing devices, including, but not limited to, a local server, a computer terminal located in the retail store 100A, a remote computer/server, and a cloud server. The retail execution system 110 may function as a centralized control system, or it may work in conjunction with a centralized control system. The retail execution system 110 may include a processor 112 and memory 114, as described above. In some implementations, the retail execution system 110 may also include hardware (not shown) to network various computing devices together.

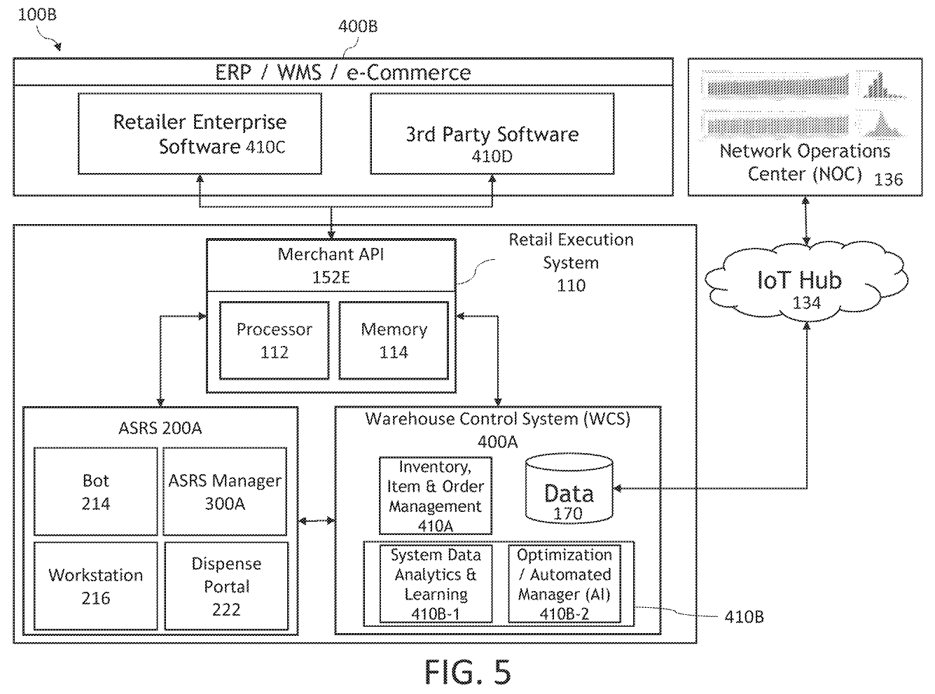

In addition to the applications 300, the retail execution system 110 may also support software and/or applications originally supported by one of the operational subsystems. For example, the retail execution system 110 may support a warehouse control system (WCS) 400A, as will be described below in FIG. 5. The WCS 400A may be a software module originally supported by the ASRS 200A and, in particular, the ASRS Manager 300A, but adapted to be operated by the retail execution system 110. The retail execution system 110 may also store and run various applications developed by one or more third parties and/or applications for a larger retail enterprise, as discussed below.

In some implementations, the WCS 400A may support a site optimization application 410B to optimize the operation of the store 100A using data related to, for example, the system, product, consumer and employee data (past and current) to optimize and control store operation yielding predictable store performance not subject to employee training, experience or bias as will be described in greater detail. Here, the site optimization application 410B employs closed loop control of overall store operations combining the automated picking system (automation) and traditional (non-automation) store operations using data from the system, bots, and store operations (including) to best manage route, dispatch both the automation and non-automation, and to fully optimize the store’s consumer experience, operating cost/profit and other benefits.

### 2.3 An Example Retail Store With Enterprise Software, Third Party Software, and a Warehouse Control System

FIG. 5 is a block diagram of another example retail store 100B with a retail execution system 110. In this example, the retail execution system 110 is configured to interface with software modules that were not designed necessarily to be executed solely by the retail execution system 110. For example, the retail execution system 110 is communicatively coupled to a warehouse control system 400A originally supported by the ASRS 200A. As shown, the WCS 400A supports an inventory management application 410A and a site optimization application 410B. As shown, the site optimization application 410B includes system data analytics and learning application 410B-1 and an optimization solver 410B-2. The retail execution system 110 is also shown to be communicatively coupled to an enterprise retail planning (ERP), a warehouse management system (WMS), and/or an e-commerce software 400B with a retail enterprise software application 410C and 3^{rd} party software applications 410D developed. Additionally, the retail execution system 110 may support several applications, including the warehouse control system 400A, which, in turn, includes an inventory, item and order management application module 410A and a site optimization application 410B with system data analytics and learning 410B-1.

The retail execution system 110 may also be communicatively coupled to one or more operational subsystems, such as the ASRS 200A, as described above. As shown, the ASRS 200A may comprise ASRS Manager 300A, bot 214, a workstation 216, and a dispense portal 222 (as well as other components shown and discussed in connection with other figures). As noted above, other types of ASRS (e.g., without bots, those using conveyors and/or gantries, etc.) are also contemplated as operational subsystems with which the retail execution system 110 may communicate. Here, the configured warehouse control system 400A may utilize a microservices architecture purpose-built for grocery or alternately any suitable architecture. Further, the warehouse control system 400A may utilize digitization of store operation and automation together to enable, for example, high accuracy inventory tracking and management. The data 170 may be leveraged by each of the modules where site data may be ported through an IoT hub 134 for remote operations, for example within a remote service and support or Network operations center (NOC) 136. Here, the bot sensor data and system performance analytics may be provided to enable machine learning across multiple sites where the systems continuously improve. Further, industrial IoT feed may be provided for some or all performance and alarm data to the NOC 136 enabling scalable remote diagnosis and control. As will be described in greater detail, the site optimization application 410B uses system, product, consumer, and employee data (past and current) to optimize and control store operation resulting in predictable store performance not subject to employee training, experience or bias.

The retail execution system 110 may also interface with the enterprise ERP/WMS/e-Commerce application 400B via a merchant API 152E. Here, the merchant API 152E may be configured and provided to easily interface with new or different retailers and third-party software applications. The ERP/WMS/e-Commerce application 400B may include software modules associated with the retail enterprise 410C and 3rd party applications 410D. For example, enterprise software 410C may be a “store management system” (or alternately or shared as part of local site applications 300) that tracks what inventory is present and has basic rules regarding replenishment. Here, the WMS 400B may not be a real time system where instead WMS 400B runs a report and orders more product and further looks at inventory and processes orders. By contrast, WCS 400A has material control system and robotic control that executes inventory and order requests, replenishment orders etc., and has access to inventory and order information from the WMS 400B.

### 2.4 An Example Retail Store With Off-Site and On-Site Software

FIG. 6 shows another block diagram of an example retail store 100C with an enterprise or “off-site” software portion 500. The retail store 100C is an example that does not include a retail execution system 110, in part, to demonstrate that the site optimization application 410B may be utilized with or without a retail execution system 110. The site optimization application 410B can use automation and other system, product, consumer, and employee data (past and current) to optimize and control store site operation resulting in predictable store performance not subject to employee training, experience or bias. The site optimization application 410B utilizes one or more databases 412 to store and/or access data associated with site operations, for example, inventory, supply chain, customer, employee, other site data, other such data, or a combination of two or more of such data.

The site optimization application 410B can further utilize one or more machine learning models 414, for example representing a numerical model, for one or more retail sites which may include, but is not limited to, one or more of an inventory model, an employee behavior model, a capacity model, a customer behavior model, and one or more machine models (e.g., a mobile robot model, a workstation model, a dispense portal model, an overall ASRS model). In one example implementation, at least two human models are employed (e.g., employee and associate) and at least two machine models are employed (e.g., mobile robot and ASRS workstation). The site optimization application 410B can further comprise and/or utilize a simulator 416 where the simulator 416 can be capable of simulating one or more aspects of the site operations over a given interval of time where the interval of time may be shorter, for example, for 5 minutes, 8 minutes, 12 minutes, or longer, for example, for a 6-hour period, an 18- hour period, a 24-hour period or otherwise in each case. Here the interval may be a variable based on the desired outcome.

An example simulation tool may be from Any Logic in Oakbrook Terrace, Illinois, which may include both discrete event (e.g., for machine modelling) and/or agent based (for humans) modelling (see, for example, www.anylogic.com). The site optimization application 410B may further comprise and/or utilize a solver 418 where the solver 418 may be a multivariable solver that is, for example, an optimization solver for linear, non-linear, mixed-integer and/or quadratic programming. An example solver is a CPLEX OPTIMIZER (TM) from Information Business Machine (IBM) (see, for example, www.ibm.com/analytics/cplex-optimizer). Here, the solver 418 may accept optimization criteria for variables intended to be optimized in conjunction with an operational model. By way of comparison, the simulator 416 simulates discrete events whereas the solver 418 sits above the simulation to optimize and make decisions. Although simulator 416 and solver 418 are shown as separate modules, in some implementations, they may be combined with other modules, such as the database 412 to form the site optimization application 410B.

As will be described, associates participate in establishing business priorities in the site optimization application 410B where the solver 418 can be used in combination with the simulator 416 to make decisions. Here, the site optimization system 410B may learn over time by adjusting an operational plan to automate store operations, digitize inventory, automate the fulfillment and apply rules to optimize a given site. In some embodiments, the optimization solver 418 and simulator 416 work together through an iterative process whereby they cooperate to repeatedly simulate a scenario that the solver is at on a given step and loop applying variations until the solver provides a scenario that hits one or more thresholds and/or a peak optimization with a workable scenario. The site optimization application 410B thus substantially takes human factors out of the decision process substantially eliminating bias and pushes to utilize a given site to the edge of the site’s operational capability without the human bias, for example, toward being conservative. Further, the site optimization application 410B may utilize data from multiple retail stores 100 (see, for example, FIG. 2) to increase the amount of data available so the learning cycle can be compressed across the sites. Here, the same rich data from multiple sites may be factored into each operation where data that is not applicable, for example geographic specific data may be removed or filtered between the sites.

The site optimization application 410B may interface directly or indirectly with an ASRS 200A where the ASRS 200A may include suitable automation to facilitate order fulfillment. For example, the ASRS 200A may include the ASRS Manager 300A, bots 214, workstations 216, and safety 228. The site optimization application 410B may further interface directly or indirectly with 3rd party applications 410D-1, 410D-2, 410D-3, and so forth. For example, 3rd party applications may include 3rd party product or service providers such as food providers, opticians, banking service providers or otherwise. Here, the site optimization application 410B may not own all of the applications to which it may interface where other 3rd party applications should be plug and play. The site optimization application 410B may further interface directly or indirectly with local site applications 410 where local site applications 410 may interface with site resources such as managers and/or employees through application(s) 410E, customers through application(s) 410F and 3rd party resources through application(s) 410G. Here, by way of non-limiting example, managers and/or employees may be on site, customers may be traditional retail or e-commerce customers and 3rd party resources may be suppliers, sources of supply or contracting, delivery resources or otherwise. The site optimization application 410B may interface directly or indirectly with an enterprise application 510A and/or a distribution application 510B directly or through the local site applications 410.

The site optimization application 410B may interface with other applications and humans in any suitable manner. By way of non-limiting examples, site optimization application 410B may interface with customers via cellular, tablet, laptop, wearable systems, and/or other such interfaces for orders, status, behavior as consumer or otherwise. Similarly, geofencing applications may be utilized and buying and pick up behavior by customer may be modeled. Similarly, the site optimization application 410B may interface with employees directly via headsets, GUI or over cell service to dispatch employees and assign and monitor tasks. Here, employees may use any suitable device to interface with site optimization application 410B such as via headset, cellular, local workstations, bar scanners, GUIs at system, wearable store interface watch, visual indicators (light towers), displays for performance metrics, location tracking. A physical manager may be local or remote where the physical manager may have access to higher level dashboards, store map of employees and customers, customer experience interface(s) and management interface(s). Here, the interface to the physical manager may be focused more on the customer than the employee. Other 3rd parties may also suitably interface with site optimization application 410B, for example, suppliers, 3rd parties like food providers, banks, opticians via a store portal such that site optimization application 410B may also be utilized for the 3rd party application such as for replenishment optimization and inventory management, velocity replenishment, and rerouting.

### 3. An Example Method for Adjusting an Operational Plan

FIG. 7 shows an example method 600 for adjusting an operational plan using the site optimization application 410B, which may be supported by the retail execution system 110 or a separate system in the retail store 100 (e.g., the warehouse control system 400A). The site optimization application 410B operates as a conductor between person and machine optimizing performance across a given site in context of priorities and constraints. At the outset a set of business priorities and operational goals can be established in step 602. The business priorities and operational goals may be static or alternately may be dynamic. By way of a non-limiting example, the business priorities or operational goals may include, but is not limited to, minimizing inventory, maximizing profitability, and maximizing customer satisfaction. These priorities may stay constant for a given period of time or change, by way of non-limiting example, with consumer behavioral changes or seasonal changes. With site optimization application 410B, humans participate in establishing business priorities where the human inherent bias on the operation stops with the business priorities unless unanticipated exceptions arise where humans are required to manage such exceptions.

Given a set of business priorities and operational goals, an operational plan can then be established in light of site state data in step 604. Here, an operational plan refers to a target or projected future state of a given variable whereas state refers to actual current state of a given variable. An example operational plan, by way of non-limiting example, may include, but is not limited to, employee scheduling and deployment, inventory replenishment schedules, automation scheduling, order execution and fulfillment, targeted pick rates. An example operational state, by way of non-limiting example, may include, but is not limited to, actual pick rates, actual order fulfillment rates, actual robot availability. Here, the operational plan (future desired target operational states) and actual operational states act as optimization criteria inputs to the solver 418 optimizer in step 606 in addition to the business priorities and operational goals 510.

In step 606, the solver 418 may solve and optimize a numerical model based on constraints and make adjustments to the operational plan in light of the current operational state data 170-1 from data 170 and in light of the business priorities and operational goals resulting in an updated recommended operational plan in step 608 made up of recommended or proposed tasks and actions. The recommended operational plan acts as an input to the simulator 416 or digital twin in step 610, which simulates a simulated future state of the operation based on one or more operating models and constraints 170-2 from data 170. (A description of an exemplary digital twin may be found at www.ibm.com/topics/what-is-a-digital-twin.) The one or more simulation operating models and constraints 170-2 may be a static model and the constraints may change based on environmental conditions. For example, the changes may include, but is not limited to, weather changes impacting customer visits, supply chain disruptions, resource disruptions, and seasonal changes. The operational models may include a starting model, a capacity model, an inventory model or otherwise and utilize site constraints such as maintaining cold chain, labor, capacity constraints or otherwise. The simulation in step 610 may employ a “look ahead solver” that looks ahead with simulation in attempts to reduce or prevent the retail store 100/WCS 400A overloading one or more given resources using “look ahead simulation” where the output of the simulator 416 serves to validate or invalidate the recommended operational plan. The simulation of the recommended operation plan can be used to determine whether the recommended operational plan is predicted to comply with and/or is predicted to improve one or more aspects of operation of the retail facility in accordance with one or more of the business goals. Once the simulator 416 or digital twin outputs a simulated future state, the simulated future state is compared (step 612) against the business priorities and/or operational goals reflected in the optimization criteria used in the solver 418 optimizer in step 606 and if the plan and/or one or more goals are not met (condition 614A), the method returns to step 606 and iterates back through the solver 418. In the next iteration, new constraints based on the simulation output and recommended operational plan where the plan was not met or optimized are applied. The utilization of digital twins employs digital models to replicate one or more systems’ various processes within one or more virtual environments enabling simulations on largely scales and/or run any number of useful simulations in order to study multiple processes. In some implementations, digital twins can be designed around a two-way flow of information that first occurs when information is provided relevant to the system processor and then happens again when insights created by the processor are shared back with the original source subsystem. By having better and constantly updated data related to a wide range of areas, combined with the added computing power that accompanies a virtual environment, digital twins are able to study more issues from far more vantage points, and typically with greater ultimate potential to improve processes.

Additionally or alternatively, in some embodiments, the operational optimization process 600 can repeat at least steps 606, 608 and 610 multiple times to generate multiple different potential operational plans that can be simulated, and the predicted future states evaluated to identify one of the multiple different potential operational plans that is predicted to provide an operation of the retail facility for at least a period of time that is predicted to optimize one or more of the business priorities and/or operational goals and/or align most with one or more of the business priorities and/or operational goals.

When a solution converges (condition 614B) by sufficiently satisfying the optimization criteria used for the solver 418 in step 606 (i.e., the plan is satisfied by simulation and optimized around goals representing a “validated plan with the highest priority goals that can be executed”), a new operational plan is established and updated in step 616. The new operational plan can then be set into execution via continued or adjusted deployment of resources within the site in step 618. The new operational plan can then be fed back in step 620 and used as the current operational plan in step 604 in conjunction with operational site state data 170 and business priorities and operational goals from step 602 to establish updated optimization criteria for the solver optimizer in step 606. Here, the loop may be executed on a fixed or variable interval. By way of non-limiting example, the loop may be executed every 5 or 10 minutes or as processor capacity allows. Alternately and by way of non-limiting example, the loop may be executed every day, every week or otherwise.

The disclosed site optimization application 410B looks at the difference between the expected performance and actual performance and may include an operational dashboard to visualize the performance and observe a difference between historical performance. When variances are observed in operation, the retail store 100/WCS 400A may revise the operational plan. In one example, the retail store 100/WCS 400A may update assigned tasks for store associates throughout the day so that associates are assigned tasks that are most likely to meet the desired business objectives and/or operational goals. As described above, this may be achieved, in part, by running the method 600 every 5 minutes. In another example, the retail store 100/WCS 400A may also provide directions and guidance to bots and associates particularly when tasks change. Generally, the site optimization application 410B may have access to at least a portion or, in some instances, all the data 170 and may optimize around various target metrics.

By way of comparison, a human alone can’t see all the information or process all the information (e.g., integrate performance data) and optimize the various operational subsystems 200 unlike the site optimization application 410B. Further, a human is subject to bias whereas the site optimization application 410B is purely data driven and thus, not subject to bias.

Machine learning (ML) may be employed by the site optimization application 410B to make unpredictable site performance more predictable. In some embodiments, machine learning models may be integrated into and/or applied by the solver 418 in step 606 and/or the simulator 416 in step 610 and site data may be aggregated as input data 170-1 and 170-2. Here, site data may be from the site being optimized and/or may be aggregated across multiple retail stores 100 (see retail stores 100 in FIG. 2) to reduce the learning cycle for a given retail store 100. By way of example, the personnel turnover during a typical training cycle may be so long that store associates may lack a complete cycle of learning. This level of skill and learning may operate as an input 170 (level of skill) to site optimization application 410B where the site optimization application 410B has and maintains intelligence, persistence, and continuous learning.

In operation, the site optimization application 410B can, in some embodiments, implement and optimize the operations of a micro-fulfillment center (MFC) in software. Here, the site optimization application 410B improves on the inefficient use of automation, inefficient allocation of human resources, inefficient allocation of physical resources, inefficient distribution of products, inefficient inventor management, other such inefficiencies, or a combination of two or more of such inefficiencies in order to attain optimized operational productivity of scheduled activities. The site optimization application 410B utilizes an operational control system that effectively monitors and reacts to changing assumptions by utilizing a digital twin simulation (see step 610) and real time scheduling and replanning with the goal of improving the customer experience and reducing the total cost of site implementation and operation. The system employs “look ahead simulation” (e.g., 4 hours) and selects the best operational plan to deploy for the retail store 100. For example, the look ahead simulation may be run iteratively every 5 minutes where the system adjusts by changing the operational plan and deploying the changes to the automation and/or personnel, the latter by for example headsets to respond back and accept tasks or otherwise. A scheduler may be employed that factors people in addition to the automation. The scheduler performs scheduling and uses data analytics and/or machine learning models in attempts to optimize store operations, which may include the attempted optimization of personnel (e.g., via a digital twin simulation). Here, digitization of store operations allows some or all of the operational data for the site to be consolidated for the site optimization application 410B where this digitization may be enabled by, for example, an Alphabot(TM) system, from Alert Innovations(TM), due at least in part to the Alphabot(TM) system’s tracking capabilities. The site optimization application 410B can interact with technology related to one or more of employees, site management, automation, customers and other entities utilizing interfaces such as graphical user interfaces (GUI’s) and other hardware (automation, storage, tracking). The retail facility optimization system can manage and adjust, based on factors, the site operational schedule where, for example, the system level loads mobile robots and prioritizes based on factors such as customer satisfaction, robot utilization, employee utilization and influences factors such as picking where, for example, the system allows picking to degrade based on priority if possible.

As noted above, the site optimization application 410B may be used, in part, to modify the operational plan of the retail store 100 to respond to expected and/or unexpected changes in operating conditions. The operational plan along with the change in state can be input into the solver optimizer in step 606 and a recommended operational plan can be outputted in step 608. This recommended operational plan, which can include the current state of the retail store 100, is input along with the operational model and constraints into, in some embodiments, a simulation digital twin in step 610 and the output of the simulation can be tested to assess whether one or more resources have been over committed and/or if the operational plan is predicted to actually be executed. In the event the operational plan does not appear to provide optimization, for example, is predicted to utilize too many resources and/or can’t be executed, the output of the simulation can be fed back to the solver 418 as additional constraints and/or boundary conditions (step 614A and/or 620) and the solution iterates until convergence is obtained. In some implementations, the solver 418 in step 606 may make assumptions as to what the various operational subsystems 200 can achieve without necessarily all of the physical and performance capabilities whereas, in some embodiments, the simulator 416 simulates performance via physics-based modelling physics of the actual positions and states of the various operational subsystems 200 and their respective components. The solver 418 and the simulator 416 can be iterated one or more times until one or more solutions that satisfy conditions are identified, and/or until a predicted optimum solution is achieved with the solver making assumptions about the physics of the various operational subsystems 200 and the simulator using physical states of the system(s).

Some embodiments provide retail facility control systems comprising: at least one retail operational subsystem 200, a retail execution system 110, at least one data repository 130, a control circuit 112, and a solver module 418. The retail operational subsystem 200 can comprise an automated storage and retrieval system (ASRS) 200A to automatically store and retrieve respective products of a plurality of products to and from corresponding designated storage locations in the ASRS and facilitate fulfillment of a customer order that includes at least one product from the plurality of products. The retail execution system 110 can be communicatively coupled to the ASRS to receive ASRS data 170 associated with operation of the ASRS, and to a plurality of retail applications 300 to obtain customer-related data, associate-related data, and retail facility-related data. The data repository 130 can be communicatively coupled to the retail execution system to store the ASRS data, the customer-related data, the associate-related data, and the retail facility-related data.

The solver module 418 can communicatively couple with the at least one data repository. In some applications, the solver module is configured to be executed by the control circuit 112 to: access business priorities and operational goals defined for a retail facility; and define a recommended operational plan based on the customer-related data, associate-related data, retail facility-related data, and the ASRS data, wherein the recommended operational plan is intended to be implemented at the retail facility and predicted to enhance operation of the retail facility consistent with one or more of the business priorities and the operational goals. The retail execution system, in some embodiments, can be configured to control the ASRS in accordance with the recommended operational plan. The solver module, in defining the recommended operational plan, can be configured to process at least the customer-related data, the associate-related data, and the facility-related data using one or more optimization algorithms.

The retail facility control system 302, in some embodiments, further comprises a simulator module 416 configured to be executed by the control circuit 112 to apply one or more simulator machine learning models to the recommended operational plan and simulate events at the retail facility to predict future states, and evaluate the predicted future states relative to the recommended operational plan in validating the recommended operational plan. The simulator module can be configured to simulate, for example, one or more of associate task performance and ASRS product retrieval performance. The solver module 418 can be configured, in some implementations, to iteratively define multiple recommended operational plans that could be implemented at the retail facility and predicted to enhance operation of the retail facility consistent with one or more of the business priorities and the operational goals. Further, the simulator module 416 can be configured to be executed by the control circuit to apply one or more simulator machine learning models to each of the multiple recommended operational plans and simulate events at the retail facility to predict future states, and evaluate the predicted future states relative to one or more of the multiple recommended operational plans to identify a first recommended operational plan of the multiple recommended operational plans that is met by the respective predicted future states.

In some embodiments, the retail execution system is configured to adjust the operation of the ASRS 200A and to control an associate resource to adjust deployment of one or more associates at the retail facility in executing the first recommended operational plan. The simulator module 418 can be configured to apply digital twins implementing digital models to simulate one or more processes within respective one or more virtual environments. Additionally or alternatively, the simulator module can, in some embodiments, be configured to be executed by the control circuit to run a simulation of one or more site operational events based on a digital representation of at least one system executed operation and at least one human executed operation predicting states of operation corresponding to the site operational events and evaluate whether the predicted states meet the recommended operational plan. The retail facility control system 302 can further include a site optimization module configured to be executed by the control circuit to direct control of retail facility operational subsystems to implement the recommended operational plan at the retail facility. The solver module 418 can be configured, in some implementations, to apply one or more solver machine learning models to retail facility data from multiple different retail facilities in determining the recommended operational plan. In some embodiments, the retail facility control system 302 can include and/or be is in communication with multiple retail execution systems each associated with one or more different retail facilities, and can apply machine learning models from other retail execution systems and/or developed for other retail facilities. For example, a solver module of a first retail execution system 110 and associated with a first retail facility 100 can apply a solver machine learning model to retail facility data in determining the recommended operational plan, and a second retail execution system associated with a second retail facility can be configured to apply that solver machine learning model to additional retail facility data corresponding to the second retail facility in determining a second recommended operational plan corresponding to the second retail facility.

Further, in some applications, the solver module can be configured to access business priorities and operational goals defined for multiple retail facilities, and define multiple recommended operational plans each configured to be implemented at a respective one of the multiple retail facilities predicted to respectively enhance operation of each of the retail facilities consistent with one or more of the business priorities and the operational goals. The solver module, in some embodiments, can be configured to access business priorities and operational goals defined for a retail entity controlling multiple different retail facilities located at different geographic locations and comprising the retail facility, and define the recommended operational plan to be implemented relative to two or more of the multiple different retail facilities predicted to respectively enhance operation of each of the two or more of multiple different retail facilities consistent with one or more of the business priorities and the operational goals.

Some embodiments provide methods of controlling retail facilities, comprising: storing and retrieving a plurality of products within an automated storage and retrieval system (ASRS), of a plurality of retail operational subsystems of a retail facility, to and from corresponding designated storage locations in the ASRS and facilitating fulfillment of customer orders that each include at least one product from the plurality of products; obtaining, from a plurality of retail operational applications corresponding to the retail facility, customer-related data, associate-related data, and retail facility-related data; receiving ASRS data associated with operation of the ASRS; and storing the ASRS data, the customer-related data, the associate-related data, and the facility-related data; accessing, through a solver module configured to be executed by a control circuit, business priorities and operational goals defined for the retail facility; and defining a recommended operational plan based on the customer-related data, associate related data, retail facility-related data and the ASRS data, wherein the recommended operational plan is intended to be implemented at the retail facility and predicted to enhance operation of the retail facility consistent with one or more the business priorities and the operational goals. One or more methods can control the ASRS in accordance with the recommended operational plan. Further, some methods apply one or more simulator machine learning models to the recommended operational plan; simulating events at the retail facility predicting future states; and evaluating the predicted future states relative to the recommended operational plan, which can in some instances can be used at least in part to validate the recommended operational plan.

The simulation of the events can, in some implementations, comprise simulating one or more of associate task performance and ASRS product retrieval performance. Some embodiments iteratively defining multiple recommended operational plans that could be implemented at the retail facility and predicted to enhance operation of the retail facility consistent with one or more of the business priorities and the operational goals. One or more simulator machine learning models can be applied to each of the multiple recommended operational plans, in some embodiments, to simulate events at the retail facility predicting future states; and evaluating the predicted future states relative to one or more of the multiple recommended operational plans and identifying a first recommended operational plan of the multiple recommended operational plans predicted to satisfy an optimization criteria within a criteria threshold. Some embodiments, in executing the first recommended operational plan, can cause adjustments for example to an operation of the ASRS and controlling an associate resource to adjust deployment of one or more associates at the retail facility. Further, in some embodiments, the simulating of the recommended operational plan can comprise applying digital twins implementing digital models simulating one or more processes within respective one or more virtual environments. The simulation can, in some applications, include simulating one or more site operational events based on a digital representation of at least one system executed operation and at least one human executed operation and predicting states of operation corresponding to the site operational events and evaluating whether the predicted states meet the recommended operational plan.

Some embodiments provide retail facility control systems, comprising: a data repository; and a retail execution system communicatively coupled with the data repository and comprises: a control circuit; a solver module configured to be executed by the control circuit to: access business priorities and operational goals defined for a retail facility; and process at least the customer-related data, the associate-related data, and the facility-related data using one or more optimization algorithms to define a recommended operational plan, wherein the recommended operational plan to be implemented at the retail facility predicted to enhance operation of the retail facility consistent with one or more of the business priorities and the operational goals; and a site optimization module configured to be executed by the control circuit to direct implementation at the retail facility of the recommended operational plan.

Some embodiments provide retail facility control systems 302 that comprise at least one retail operational subsystem 200, a retail execution system 110, and at least one data repository 130. The retail operational subsystem 200 can comprise an ASRS 200A to automatically store and retrieve respective products of a plurality of products to and from corresponding designated storage locations in the ASRS and facilitate fulfillment of a customer order that includes at least one product from the plurality of products. The retail execution system 110 can be communicatively coupled to the ASRS to receive ASRS data 170 associated with operation of the ASRS, and communicatively coupled to a plurality of retail applications 300 to obtain customer-related data, associate-related data, and store-related data. The one or more data repositories 130 can communicatively couple to the retail execution system, to store the ASRS data, the customer-related data, the associate-related data, and the store-related data. The retail execution system 110, in some implementations, can be is configured to control the ASRS based at least in part on processed customer-related data, associate-related data, and store-related data.

The retail facility control system can further include a solver module 418, which can be configured to be executed by one or more control circuits, and communicatively coupled with the data repository 130. The solver module 418 can be configured to access business priorities and operational goals defined for a retail facility and define a recommended operational plan to be implemented at the retail facility predicted to enhance operation of the retail facility consistent with one or more of the business priorities and/or the operational goals. In some applications, the solver module 418 can access business priorities and operational goals defined for multiple retail facilities and recommended operational plans to be implemented at each of the multiple retail facilities predicted to respectively enhance operation of each of the retail facilities consistent with one or more of the business priorities and the operational goals. Similarly, in some embodiments, the solver module 418 can define for a retail entity controlling multiple different retail facilities located at different geographic locations, and a recommended operational plan to be implemented relative to one or more of the retail facilities predicted to respectively enhance operation of each of the one or more of retail facilities consistent with one or more of the business priorities and the operational goals.

The retail facility control system, in some embodiments, can include a simulator module 416 configured to apply one or more simulator machine learning models to the recommended operational plan and simulate events at the retail facility to predict future states, and evaluate the predicted future states relative to the business priorities and the operational goals to validate the recommended operational plan. The simulator module 416, for example, can be configured to simulate one or more of associate task performance and ASRS product retrieval performance. A solver module 418 may further be included and be communicatively coupled with the data repository 130. The solver module can be configured to access business priorities and operational goals defined for a retail facility and iteratively define multiple recommended operational plans that could be implemented at the retail facility predicted to enhance operation of the retail facility consistent with one or more of the business priorities and the operational goals. The simulator module 416 can be configured to apply one or more simulator machine learning models to each of the multiple recommended operational plans and simulate events at the retail facility to predict future states, and evaluate the predicted future states relative to the business priorities and the operational goals to identify a first recommended operational plan of the multiple recommended operational plans that is met by the respective predicted future states.

In some embodiments, the retail execution system 110 is configured to execute one or more recommended operational plans to adjust the operation of the ASRS. Additionally or alternatively, the retail execution system can execute a recommended operational plan to control an associate resource to adjust deployment of one or more associates at the retail facility. The retail operational subsystem can include one or more of a HVAC system, a refrigeration system, an ordering kiosk, and payment kiosk. The plurality of retail applications 300 can comprise one or more of an inventory management application, a point-of-service (POS) application, a mobile customer ordering application, an order management application, a labor management application, and a fleet management application.

Some embodiments provide a retail facility control system 302 that include at least one data repository 130 and a retail execution system 110. The data repository can be configured to store customer-related data, associate-related data, and facility-related data. The retail execution system 110 can communicatively couple with the data repository and can comprise: a control circuit 112, a solver module 418 and a site optimization module 410B. The solver module 418 can be configured to be executed by the control circuit to: access business priorities and operational goals defined for a retail facility; process at least the customer-related data, the associate-related data, and the facility-related data using one or more optimization algorithms to define a recommended operational plan, wherein the recommended operational plan to be implemented at the retail facility predicted to enhance operation of the retail facility consistent with one or more of the business priorities and the operational goals. The site optimization module 410B can be configured to be executed by the control circuit to communicate the recommended operational plan and/or direct implementation at the retail facility of the recommended operational plan. The recommended operational plan can, in some implementations, define one or more of self-serve retail store operations, fulfillment operations for in-store customer pickup, fulfillment operations for ecommerce orders, distribution center operations, and/or operations for an automated storage and retrieval system.

The retail execution system 110 can further comprise a simulator module 416 that can be configured to be executed by the control circuit to run a simulation of the recommended operational plan and/or modifications to a recommended operational plan based on a digital representation of at least one system executed operation and/or at least one human executed operation to evaluate whether predicted future states meet the operational plan in predicting whether the recommended operational plan is expected meet one or more of the business priorities and the operational goals. The simulator module 416, in some applications, can be configured to be executed by the control circuit to run a simulation of one or more site operational events based on a digital representation of at least one system executed operation and at least one human executed operation to predict states of operation corresponding to the site operational events and evaluate whether the predicted states meet the recommended operational plan. The one or more of the business priorities and the operational goals can include, for example, one or more of minimizing inventory, improving profitability, and improving customer satisfaction. One or more of the business priorities and operational goals typically vary over time based on consumer behavioral changes.

The simulator module 416, can further be configured to run the simulation relative to a predefined future duration of time. In some embodiments, the simulator module 416 can be configured to apply digital twins implementing digital models to simulate one or more processes within respective one or more virtual environments. The recommended operational plan, in some instances, can define for example one or more of employee scheduling and deployment, inventory replenishment schedules, automation scheduling, order execution and fulfillment, and targeted pick rates.

Some embodiments provide a retail facility control system 302 that comprises: a control circuit 112, a solver module 418 configured to be executed by the control circuit, a simulator module 416, and a site optimization module 410B. The solver module can be configured to access business priorities and operational goals defined for a retail facility, apply one or more optimization algorithms to define a recommended operational plan based on customer-related data, associate-related data, and facility-related data. The recommended operational plan or part of the recommend operational plan is configured to be implemented at the retail facility and is predicted to enhance operation of the retail facility consistent with one or more of the business priorities and the operational goals. The simulator module 416, in some embodiments, is configured to be executed by the control circuit to simulate the recommended operational plan to predict future states of operation of one or more events at the retail facility, and evaluate the predicted future states relative to the business priorities and the operational goals to validate the recommended operational plan. The site optimization module 410B can be configured to be executed by the control circuit 112 to direct control of retail facility operational subsystems to implement the recommended operational plan at the retail facility.

A retail facility control system 302 is provided in some embodiments that includes one or more data repositories 130, a control circuit 112 and a solver module 418. The data repository 130 can be configured to store customer-related data, associate-related data, and/or facility-related data each received from one or more of a plurality of retail applications 300 and/or operational subsystems 200. The control circuit 112 can communicatively couple with the data repository 130. The solver module 418 can be configured to be executed by the control circuit to: access business priorities and operational goals defined for a retail facility; and apply one or more optimization algorithms to define a recommended operational plan that is configured to be implemented at the retail facility and is predicted to enhance operation of the retail facility consistent with one or more of the business priorities and the operational goals.

Some embodiments provide retail facility control system 302 that can include one or more data repositories 130, a control circuit 112, a simulator module 416 and a site optimization module 410B. The one or more data repositories 130 can be configured to store data, such as one or more of customer-related data, associate-related data, and facility-related data each received from one or more of a plurality of retail applications 300. The control circuit 112 can communicatively couple with at least one data repository. The simulator module 416 can be executed by the control circuit to: simulate a recommended operational plan based on the customer-related data, the associate-related data, and the facility-related data, where the recommended operational plan is intended to be implemented at a retail facility and is predicted to enhance operation; predict, based on the simulation, future states of operation of events at the retail facility; and evaluate the predicted future states relative to business priorities and operational goals to validate the recommended operational plan. The site optimization module can be configured to be executed by the control circuit 112 to direct control of retail facility operational subsystems 200 to implement the recommended operational plan at the retail facility when validated.

Some embodiments provide retail facility control system 302 comprising: at least one data repository 130 and a retail execution system 110. The retail execution system can communicatively couple with the data repository, a plurality of retail applications 300 configured in part to provide customer-related data, associate-related data, and/or facility-related data, and a plurality of retail facility operational subsystems 200 operating at a retail facility maintaining products at the retail facility. The retail execution system 110 can comprises: a control circuit and a site optimization module 410B. The site optimization module can be configured to be executed by the control circuit to: receive the customer-related data, the associate-related data, and the facility-related data; and obtain a recommended operational plan based on the customer-related data, the associate-related data, the facility-related data, and current states of operation of the plurality of retail facility operational subsystems. The recommended operational plan is configured to be implemented by one or more of the plurality of the retail facility operational subsystems 200 at the retail facility and is predicted to enhance operation of the retail facility consistent with one or more business priorities and operational goals. The site optimization module 410B can, in some implementations, communicate the recommended operational plan to control the one or more of the plurality of retail facility operational subsystems 200 to implement the recommended operational plan or modifications consistent with the recommended operational plan.

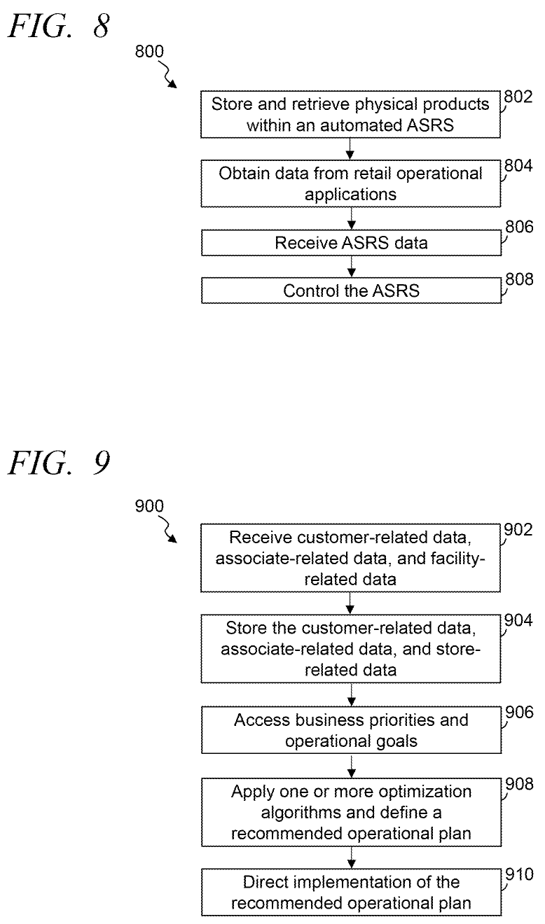

Some embodiments provide methods of controlling retail facilities. FIG. 8 illustrates a simplified flow diagram of an exemplary process 800 of controlling one or more retail facilities, in accordance with some embodiments. In step 802, physical products can be store and retrieve within an automated ASRS operational subsystem 200A of a plurality of retail operational subsystems of the retail facility. The products can be stored to and retrieved from corresponding designated storage locations in the ASRS in the facilitation of fulfilling customer orders that each include at least one product from the plurality of products. In step 804, customer-related data, associate-related data, and store-related data can be obtained from a plurality of retail operational applications 300 corresponding to one or more retail facilities. In step 806, some embodiments further receive ASRS data associated with operation of the ASRS 200A, and can store the ASRS data, the customer-related data, the associate-related data, and the store-related data. In step 808, the ASRS 200A can be controlled based at least in part on the customer-related data, associate-related data, and store-related data. Some embodiments process of the customer-related data, the associate-related data, and/or the facility-related data by accessing, through a solver module 418, business priorities and operational goals defined for the retail facility. A recommended operational plan can be defined to be implemented at the retail facility dictating the control of the ASRS and predicted to enhance operation of the retail facility consistent with one or more the business priorities and the operational goals.

One or more simulator machine learning models can be applied, in some embodiments, relative to the recommended operational plan in simulating events at the retail facility predicting future states. The predicted future states can be evaluated relative to the business priorities and operational goals to validate the recommended operational plan. Some embodiments simulate one or more of associate task performance and ASRS product retrieval performance. A solver module 418 can access the business priorities and operational goals defined for a retail facility. The business priorities and/or operational goals, in some implementations, includes maximizing customer satisfaction.

In some embodiments, multiple recommended operational plans can iteratively be defined that could be implemented at the retail facility predicted to enhance operation of the retail facility consistent with one or more of the business priorities and the operational goals. One or more simulator machine learning models can be applied, in some embodiments, to each of the multiple recommended operational plans simulating events at the retail facility predicting future states. The predicted future states can be evaluated relative to the business priorities and operational goals in identifying a first recommended operational plan, of the multiple recommended operational plan, predicted to satisfy an optimization criteria within a criteria threshold. The first recommended operational plan can be executed to adjust the operation of the ASRS. The execution of the first recommended operational plan can further comprise causing an associate resource to adjust deployment of one or more associates at the retail facility. As described above, the retail operational subsystems can include, for example, one or more of a HVAC system, a refrigeration system, an ordering kiosk, and payment kiosk. The plurality of retail applications can comprise one or more of an inventory management application, a point-of-service (POS) application, a mobile customer ordering application, an order management application, a labor management application, and a fleet management application.

FIG. 9 illustrates a simplified flow diagram of an exemplary process 900 of controlling retail facilities, in accordance with some embodiments. In step 902, customer-related data, associate-related data, and facility-related data can be received, for example, through a retail execution system 110 of a retail facility. In some implementations, one or more of the customer-related data, associate-related data, and facility-related data can be received from a plurality of retail operational applications 300. In step 904, the customer-related data, the associate-related data, and the facility-related data can be stored within at least one data repository 130 communicatively coupled with the retail execution system. In step 906, business priorities and operational goals defined for the retail facility can be accessed by a solver module 418 executed by a control circuit of the retail execution system. In step 908, one or more optimization algorithms can be applied by the solver module to customer-related data, the associate-related data, and/or the facility-related data to define a recommended operational plan to be implemented at the retail facility predicted to enhance operation of the retail facility consistent with one or more the business priorities and the operational goals. In step 910, a site optimization application can direct the implementation of the recommended operational plan.

In some embodiments the recommended operational plan defines one or more of self-serve retail store operations, fulfillment operations for in-store customer pickup, fulfillment operations for ecommerce orders, distribution center operations, and operations for an automated storage and retrieval system. Some embodiments simulate the recommended operational plan based on a digital representation of at least one system executed operation and at least one human executed operation to evaluate whether predicted future states are expected to meet the recommended operational plan the recommended operational plan. The business priorities and operational goals can comprise, for example, one or more of minimizing inventory, improving profitability, and improving customer satisfaction. One or more of the business priorities and operational goals can vary over time based on consumer behavioral changes. The simulation of the recommended operational plan can include simulating the recommended operational plan relative to a predefined future duration of time. Some embodiments simulate the recommended operational plan by at least in part applying digital twins implementing digital models simulating one or more processes within respective one or more virtual environments. The recommended operational plan, in some implementations, can define one or more of employee scheduling and deployment, inventory replenishment schedules, automation scheduling, order execution and fulfillment, and targeted pick rates. Some embodiments simulate one or more site operational events based on a digital representation of at least one system executed operation and at least one human executed operation to predict states of operation corresponding to the site operational events, evaluate whether the predicted states meet the recommended operational plan.

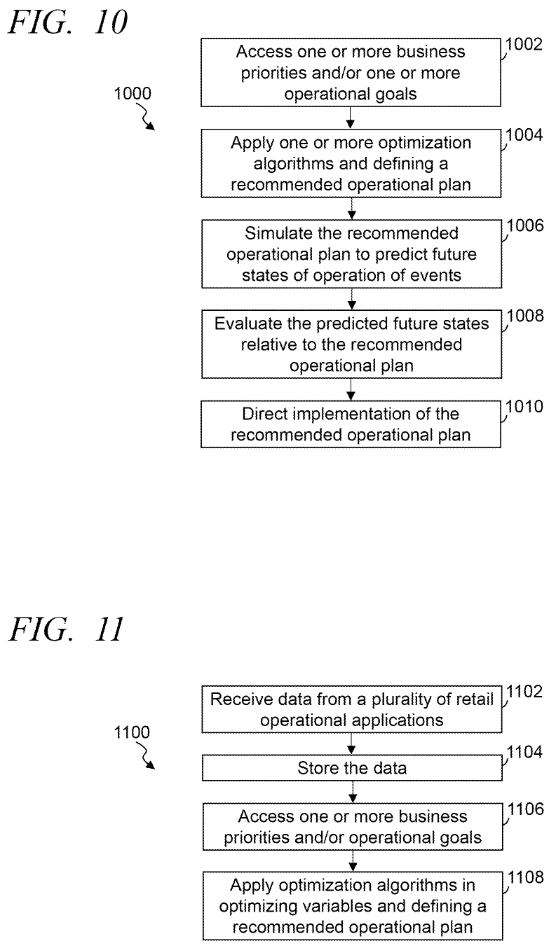

FIG. 10 illustrates a simplified flow diagram of an exemplary process 1000 of controlling retail facilities in accordance with some embodiments. In step 1002, one or more business priorities and/or one or more operational goals are accessed through a solver module 418 executed by one or more control circuits. As described above, the business priorities and/or operational goals can be defined for one or more retail facilities. In step 1004, one or more optimization algorithms can be applied by the solver module 418 defining a recommended operational plan based on customer-related data, associate-related data, facility-related data, ASRS data and/or other data. The recommended operational plan is configured to be implemented at the retail facility and is predicted to enhance operation of one or more retail facilities consistent with one or more of the business priorities and/or the operational goals. In step 1006, the recommended operational plan is simulated to predict future states of operation of events at the retail facility. In step 1008, the predicted future states can be evaluated relative to the one or more business priorities and/or the operational goals to validate the recommended operational plan. In step 1010, implementation of the recommended operational plan is directed at the retail facility. In some embodiments, one or more retail operational applications 300 can be controlled to implement one or more aspects of the recommended operational plan.

FIG. 11 illustrates a simplified flow diagram of an exemplary process 1100 of controlling operations at one or more retail facilities, in accordance with some embodiments. In step 1102, customer-related data, associate-related data, store-related data, ASRS data and/or other data is received from a plurality of retail operational applications 300. In step 1104, the customer-related data, the associate-related data, the store-related data and/or other data can be stored in at least one data repository 130. In step 1106, one or more business priorities and/or operational goals defined for the retail facility can be accessed by one or more solver modules 418 executed though one or more control circuits 112. In step 1108, the solver module can apply one or more optimization algorithms in optimizing variables and defining a recommended operational plan based on the processing of the customer-related data, the associate-related data, the store-related data and/or other data. The recommended operational plan is to be implemented by one or more facility subsystems at the retail facility and is predicted to enhance operation of the retail facility consistent with one or more of the business priorities and/or the operational goals.

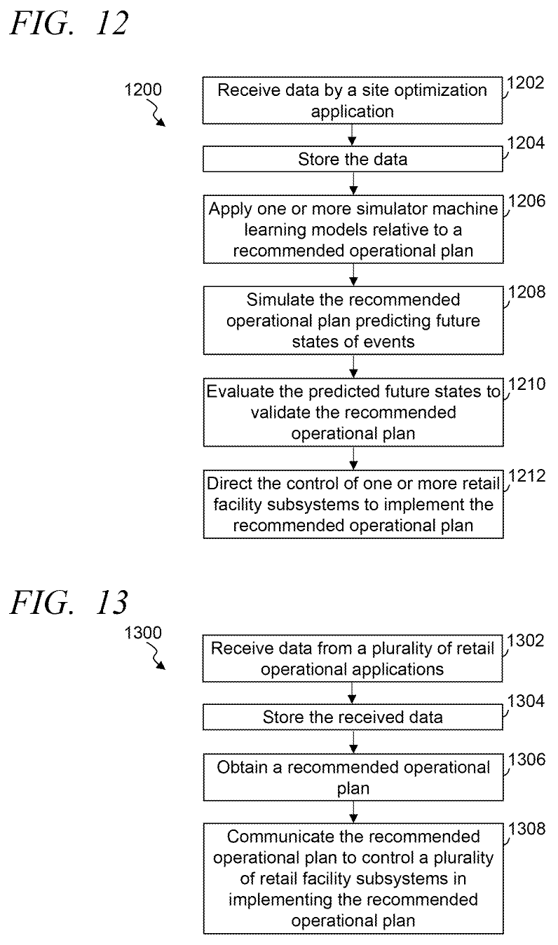

FIG. 12 illustrates a simplified flow diagram of an exemplary process 1200 of controlling retail facilities, in accordance with some embodiments. In step 1202, customer-related data, associate-related data, store-related data, ASRS data and/or other data is received by a site optimization application from a plurality of retail operational applications 300. In step 1204, the customer-related data, the associate-related data, the store-related data and/or other data can be stored in at least one data repository 130. In step 1206, one or more simulator machine learning models can be applied relative to a recommended operational plan predicted to enhance operation at the retail facility. In step 1208, the recommended operational plan can be simulated predicting future states of operation of events at the retail facility. In step 1210, the predicted future states can be evaluated relative to business priorities and operational goals to validate the recommended operational plan. In step 1212, control can be directed of one or more retail facility operational subsystems to implement the recommended operational plan at the retail facility when validated.

FIG. 13 illustrates a simplified flow diagram of an exemplary process 1300 of controlling retail facilities, in accordance with some embodiments. In step 1302, one or more of customer-related data, associate-related data, and facility-related data can be received at a retail execution system 110 from a plurality of retail operational applications 300. In step 1304, the customer-related data, the associate-related data, and/or the store-related data can be stored in at least one data repository 130. In step 1306, a recommended operational plan can be obtained based on one or more customer-related data, the associate-related data and the facility-related data, and current states of operation of the plurality of retail facility operational subsystems. The recommended operational plan is configured to be implemented by the plurality of the retail facility operational subsystems at the retail facility and is predicted to enhance operation of the retail facility consistent with one or more business priorities and/or operational goals. In step 1308, the recommended operational plan can be communicated to control the plurality of retail facility subsystems can be controlled through one or more of the plurality of retail facility operational subsystems to implement the recommended operational plan.

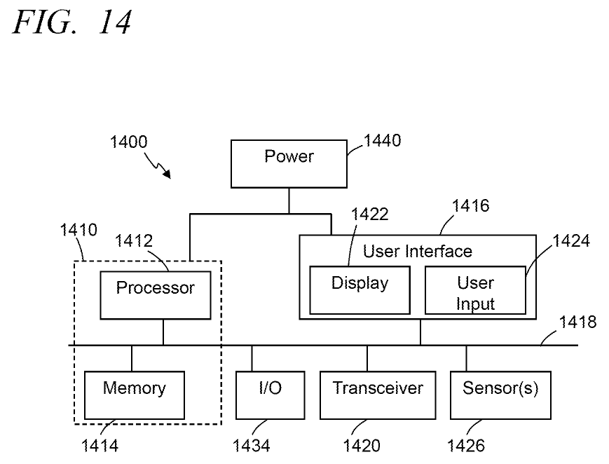

Further, the circuits, circuitry, systems, devices, processes, methods, techniques, functionality, services, servers, sources and the like described herein may be utilized, implemented and/or run on many different types of devices and/or systems. FIG. 14 illustrates an exemplary system 1400 that may be used for implementing any of the components, circuits, circuitry, systems, functionality, apparatuses, processes, or devices of the retail facility control systems and/or facilities, and/or other above or below mentioned systems or devices, or parts of such circuits, circuitry, functionality, systems, apparatuses, processes, or devices. For example, the system 1400 may be used to implement some or all of the retail facilities (such as retail stores 100, fulfillment centers, distribution centers 14, retail entities, MDCs 18, for example). However, the use of the system 1400 or any portion thereof is certainly not require.

By way of example, the system 1400 may comprise one or more control circuits or processor modules 1412, one or more memory 1414, and one or more communication links, paths, buses or the like 1418. Some embodiments may include one or more user interfaces 1416, and/or one or more internal and/or external power sources or supplies 1440. The control circuit 1412 can be implemented through one or more of, but not limited to, processors, microprocessors, central processing unit, application-specific integrated circuit (ASIC), a field-programmable gate array (FPGA), logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1412 can be part of control circuitry and/or a control system 1410, which may be implemented through one or more processors with access to one or more memory 1414 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1400 may be used to implement one or more of the above or below, or parts of, components, circuits, systems, processes and the like.

The user interface 1416 can allow a user to interact with the system 1400 and receive information through the system. In some instances, the user interface 1416 includes a display 1422 and/or one or more user inputs 1424, such as buttons, touch screen, track ball, keyboard, mouse, etc., which can be part of or wired or wirelessly coupled with the system 1400. Typically, the system 1400 further includes one or more communication interfaces, ports, transceivers 1420 and the like allowing the system 1400 to communicate over a communication bus, a distributed computer and/or communication network 610 (e.g., a local area network (LAN), the Internet, wide area network (WAN), etc.), communication link 1418, other networks or communication channels with other devices and/or other such communications or combination of two or more of such communication methods. Further the transceiver 1420 can be configured for wired, wireless, optical, fiber optical cable, satellite, or other such communication configurations or combinations of two or more of such communications. Some embodiments include one or more input/output (I/O) ports 1434 that allow one or more devices to couple with the system 1400. The I/O ports can be substantially any relevant port or combinations of ports, such as but not limited to USB, Ethernet, or other such ports. The I/O interface 1434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1426 to provide information to the system and/or sensor information that is communicated to another component, such as the central control system, bots, a delivery vehicle, etc. The sensors can include substantially any relevant sensor, such as motion sensors, distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, velocity sensors, imaging and image processing sensors, inventory sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1400 comprises an example of a control and/or processor-based system with the control circuit 1412. Again, the control circuit 1412 can be implemented through one or more processors, controllers, central processing units, ASICs, FPGAs, logic, software and the like. Further, in some implementations the control circuit 1412 may provide multiprocessor functionality.

The memory 1414, which can be accessed by the control circuit 1412, typically includes one or more processor-readable and/or computer-readable media accessed by at least the control circuit 1412, and can include volatile and/or nonvolatile media, such as RAM, ROM, EEPROM, flash memory and/or other memory technology. Further, the memory 1414 is shown as internal to the control system 1410; however, the memory 1414 can be internal, external or a combination of internal and external memory. Similarly, some or all of the memory 1414 can be internal, external or a combination of internal and external memory of the control circuit 1412. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 610. The memory 1414 can store code, software, executables, scripts, data, content, lists, programming, programs, log or history data, user information, customer information, product information, and the like. While FIG. 14 illustrates the various components being coupled together via a bus, it is understood that the various components may actually be coupled to the control circuit and/or one or more other components directly.

### 3.1 Business Priorities, Operational Goals & Metrics

The site optimization application 410B may optimize around substantially any suitable business metrics such as, but not limited to, capital expenditures (CAPEX), labor costs, operating expenditures (OPEX), and profit. Here, the site optimization application 410B may, for example, adjust operation of the retail store 100 that utilizes associates to perform various tasks while reducing variability associated with humans and human bias, such as sub-optimum performance by an associate. The site optimization application 410B may influence the use of various resources and services, such as personnel, inventory, space, pricing, automation, fixed and variable costs, customer, to optimize around system metrics. The system metrics may also be prioritized and weighted in different ways. By way of non-limiting example, in descending priority such metrics may include: (1) Customer satisfaction as measured by wait time, (2) orders per day, (3) employee utilization, (4) bot utilization or other suitable metrics.

In alternate aspects, optimization may be around other factors such as:

(1) Employee utilization, automation utilization, CSAT/wait time, or money metrics such as cash flow and profitability metrics.

(2) Margin priority where, for example, X% of customers that make up Y% of margin get priority and a factor about which to optimize may include a “priority of service” factor.

(3) Customer satisfaction metrics may include, in descending priority: 1. On time, 2. Wait time, 3. % fill rate (“get what was ordered on time”).

(4) Task splitting optimization between robotic and employee picking.

(5) Multiple factors such as optimizing around inventory position, profitability, customer satisfaction with varying weight on each.

### 3.2 Inputs and Variances

Example inputs and variances will be described. It will be appreciated by those skilled in the art that the below are merely examples and not intended to be an exhaustive list. Inputs related to the associates may include factors such as operational schedule, known orders, and staffing availability (who is available and who is not). Inputs related to automated systems (e.g., bots, conveyors, scanners, transport systems, etc.) may include factors such as system availability, number of operational bots, workstations, and other assets. Variances related to the associates may include such factors as new orders, customer arrivals, staffing availability and performance (e.g., absent for day, not following pace, wrong place). Variances related to automated systems may include system performance, bots going down, and workstation performance.

The inputs may also be based on other factors such as, but not limited to:

(1) Employee inputs to the system may include employee or resource availability, competence and habits, automation system status, operating plan, historical estimates for unknowns, and promotional impacts.

(2) Further inputs may include inventory on the floor and in the automation system and the split of inventory between the floor vs the automations system. Variables available to the system include automation and personnel capacity and tasks, inventory, space, pricing, fixed and variable costs, customers where the system optimizes the automation use by controlling the both the automation and the personnel activities.

(3) Inputs to the system may include cellular data where the site optimization application 410B can be informed based on cell phone data how many customers are in the store or in a given area and the cell data used to inform the automation for optimization of picking, fulfillment or otherwise. Here, geolocation may be used to assess when people are coming to pickup orders and thereby reduce variability.

(4) Inputs to the system may include inventory position where the system looks at the inventory of the whole MFC, including the ASRS, the sales floor, and warehouse inventory at the MFC.

(5) Inputs to the system may include customer dependability, which may be a factor based on historical timeliness. For example, if a given customer is always late or consistently late and/or not dependable, then the site optimization application 410B may deprioritize their pickup without penalty.

(6) Additional inputs may include data associated with the site operations such as: (a) ASRS system availability and system status, (b) product aging, quantities, push incentive, and (c) associate’s present and past behavior where the same may be applied for customers and product.

(7) Inputs to the site optimization application 410B may have persistence where both present and past behavior may be used to predict future behavior for all aspects of data. The site optimization application 410B may maintain statistics on inputs as well as historical system performance data to predict future behaviors. By way of example, the system may take more orders or cut off orders based on historical data to provide deliveries with confidence. Weighting for importance may be applied based on business priorities related to inputs to further facilitate a given optimization desired and weighting of elements associated with a given optimization.

(8) Non-traditional inputs may be utilized, for example, website data where clickstream data may be used to predict orders (e.g., % baskets that ripen to orders, buying habits based on clickstream).

### 3.3 Data Collection Progression

The collection of data may progress from an initial data set and increasing in scope. An example progression on the collection of data and ability to interact at progressive levels of influence is shown:

(1) Alphabot(TM) System: Using data from bots to constantly learn and improve the way bots move within the system - progression of routing (best path) to dispatching (best time) to scheduling (best planning via digital twin) based on bot and system performance.

(2) Alphabot(TM) System + Store Operations: Using data from bots and store operations (including) to best route, dispatch both the automation and to fully optimize the store’s Consumer Experience and Operating Cost (patent application in process)

(3) Alphabot(TM) System + Store Operations + Consumers: Adding Consumer (Shopper) behavior data to best route, dispatch and schedule all activities, including those of Consumers. This can include Consumer buying patterns, historical Consumer behavior (being on time for pickup, changing their order, etc.) as additional factors we learn and use to again optimize Consumer Experience and Store Operational Efficiency.

(4) Cross-Store Learning (May also be Cross Retailer): Learning from three genericized and shared between Retailers. May be a subscription service we provide where we even help Retailers where they are leading and lagging in performance vs other Retailers.

(5) Up-Stream Supply Chain Integration: Shipping to Stores quantities that match sales velocities - Completely digitizing and revolutionizing the supply chain

### 3.4 Operational Plan & Outputs

Example outputs from the system may include robot tasks, employee tasks, and inventory allocations such as the split of inventory between the floor vs the automation system. Outputs from the system may further include “planned”, “unplanned,” and “predictive” outputs. For example, the customer dispense portal may have an operational plan, which may be influenced by factors such as a given classified customer predictability where customer predictability may be classed into multiple buckets A, B, C based on factors such as historical timeliness or SKU priority and where the system may influence dispense time, priority and location based on such factors.

In another example, van dispense (small flex) may similarly be influenced. In another example, offline tote induction (employee wait time) may be scheduled and similarly influenced. In yet another example, chilled/frozen (cold chain) may be scheduled and similarly influenced. In yet another example, picking allocation (can robopick move to manual) may be scheduled and similarly influenced. Similarly, in yet another example, employee deployment may be scheduled and similarly for example where the system checks store customer density (Output - lock out employee, notify real manager). In yet another example, decant replenishment (can reschedule) may be influenced. In yet another example, functions such as hospital (flexible) and system/workstation/bot maintenance may be scheduled and influenced.

Example operational plan and outputs may further include:

(1) An example capacity output of the system may be an interface to order management where the system informs the front end “don’t take orders” when saturation is reached or predicted to be reached.

(2) An example incentive output may be put in place to level load the picking system.

(3) A portion of a given operating plan may include same day & immediacy tasks, for example, pre picking common items (ex: 10% of orders always have XYZ planned picking and unplanned picking).

(4) An operational plan for a given day may utilize a known and proven operation plan based on historical data with all or portions factored into the given day’s operational plan.

(5) Promotional activity may be factored into a given operational plan based on previous promotional activity (i.e. thanksgiving special will get spike in orders for days for products XYZ).

(6) Operational plans may utilize machine learning where system 224 can learn based on historical activity.

(7) Operational plans may utilize applications where system 224 partners and uses input from other applications for predictive use, for example, such as geofencing to predict customer behavior.

(8) Operational plans may utilize information to level load the ASRS and floor picking operations such as information like traffic patterns to suggest customer pickup times.

(9) Operational plans may leverage operator tag in and tag out where the system is sufficiently intelligent to reject operations management instructions or a given operator if it deviates from the plan. By way of example, if an operator attempts to login to a workstation outside the operational plan then the system locks them out and notifies the live manager that resource X is idle and redirects them (another function of site management).

(10) Exceptions may be provided as outputs of a given plan.

(11) Operational plans may leverage consumer behavior and modify the machine behavior accordingly such that the consumer behavior (consistently late) is linked to the machine behavior (deliver later) in an automation direct to customer application.

Accordingly, operational plans may leverage and optimize multiple operating scenarios, for example, factor in availability of floor picks, operator variability etc. to minimize variability.

### 4.1 Example Use Cases A

Tasks may be assigned based on priority of the outcome or alternately flexibility of the outcome. For example, the site optimization application 410B may assign tasks that need to be accomplished “on demand” vs “discretionary”. For example, a least flexible task may be customer dispense providing one or more products to a customer, which may be high priority in the system. A lesser priority may be order picking allocating picking resources for the automation system vs for the store floor. A still lower priority may then be decant or hospital operations.

The site optimization application 410B may prioritize based on deferrable vs real time on demand transactions. For example, chilled and frozen dispense may have time constraints that put the dispense at a higher priority compared to a purely ambient order. Similarly real time customer dispense may take priority over variable / deferrable time van dispenses.

The site optimization application 410B may prioritize tasks, for example, same day / hour discretionary actions with the system vs non-discretionary actions. For example, items where there is a lot of discretion may include replenishment or things that can be done off hours. A further example may be scheduled maintenance that may be deferred.

Picking activities may be throttled based on number of bots available. Here, the number of idle bots may be an indication of saturation of assets.

The site optimization application 410B may be applied across the entire MFC operation. For example, the site optimization application 410B may integrate store picking, automated picking and self-service picking into the entire operation. Similarly, the site optimization application 410B may look at other aspects such as replenishment or otherwise.

### 4.2 Example Use Cases B

Example simple use cases where the system needs to detect change and immediately react to provide the best customer service with the best operating economics for the retailer (most profit from increasing revenue and / or reducing costs):

Unexpected surge in orders (unexpected consumer behavior). Example where the bots nominally have the capability to execute and bring all items to the picking station where 80% of the bots are planned to be utilized for picking and 20% for replenishment by the operating plan. Now that additional orders are coming in, 90% of the bots get reallocated to capture the revenue and the replenishment deferred and reduced to 10% at no cost to the operation as the solver and simulator show that the revenue of later hours will not be impacted.

Unexpected availability of bots (some failed). Example where 70% of bots are scheduled for customer dispense and 20% for picking and 10% for replenishment. Here, as replenishment is the lowest priority and can be delayed, the 10% for replenishment is deferred to another time in order to insure the customers take priority.

Unexpected availability of store employees (e.g., called in sick, leave early). System redirects employees to support customer orders based on which activity has the highest profit.

Unexpected inventory shortage (replenishment, natural occurrence). In this event the system stops accepting orders and prioritizes the customers in the pipeline based on a metric such as profit or customer loyalty or basket size.

Unexpected arrival of customers (don’t show up on time, late early). Example where in the event too many customers arrive, the remainder of the days work is deferred based on priority of work; example where replenishment is put off to later in the day.

Unexpected failures of non-bot hardware. Example where a portal goes down and the lowest priority customer is informed to pick up later.

### Conclusion

All parameters, dimensions, materials, and configurations described herein are meant to be example and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the example implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A retail facility control system comprising:
at least one retail operational subsystem (200) comprising:
an automated storage and retrieval system (ASRS) (200A) to automatically store and retrieve respective products of a plurality of products to and from corresponding designated storage locations in the ASRS and facilitate fulfillment of a customer order that includes at least one product from the plurality of products;
a retail execution system (110), communicatively coupled to the ASRS to receive ASRS data (170) associated with operation of the ASRS, the retail execution system further communicatively coupled to a plurality of retail applications (300) to obtain customer-related data, associate-related data, and retail facility-related data;
at least one data repository (130), communicatively coupled to the retail execution system, to store the ASRS data, the customer-related data, the associate-related data, and the retail facility-related data;
a control circuit (112); and
a solver module (418) communicatively coupled with the at least one data repository and configured to be executed by the control circuit to:
access business priorities and operational goals defined for a retail facility; and
define a recommended operational plan based on the customer-related data, associate-related data, retail facility-related data, and the ASRS data, wherein the recommended operational plan is intended to be implemented at the retail facility and predicted to enhance operation of the retail facility consistent with one or more of the business priorities and the operational goals.

2. The retail facility control system of claim 1, wherein the retail execution system is configured to control the ASRS in accordance with the recommended operational plan.

3. The retail facility control system of claim 1, wherein the solver module, in defining the recommended operational plan is configured to process at least the customer-related data, the associate-related data, and the facility-related data using one or more optimization algorithms.

4. The retail facility control system of claim 1, further comprising:
a simulator module configured to be executed by the control circuit to apply one or more simulator machine learning models to the recommended operational plan and simulate events at the retail facility to predict future states, and evaluate the predicted future states relative to the recommended operational plan.

5. The retail facility control system of claim 4, wherein the simulator module is configured to simulate one or more of associate task performance and ASRS product retrieval performance.

6. The retail facility control system of claim 1, wherein the solver module is configured to iteratively define multiple recommended operational plans that could be implemented at the retail facility and predicted to enhance operation of the retail facility consistent with one or more of the business priorities and the operational goals.

7. The retail facility control system of claim 6, further comprising:
a simulator module configured to be executed by the control circuit to apply one or more simulator machine learning models to each of the multiple recommended operational plans and simulate events at the retail facility to predict future states, and evaluate the predicted future states relative to one or more of the multiple recommended operational plans to identify a first recommended operational plan of the multiple recommended operational plans that is met by the respective predicted future states.

8. The retail facility control system of claim 7, wherein the retail execution system is configured to adjust the operation of the ASRS and to control an associate resource to adjust deployment of one or more associates at the retail facility in executing the first recommended operational plan.

9. The retail facility of claim 4, wherein the simulator module is configured to apply digital twins implementing digital models to simulate one or more processes within respective one or more virtual environments.

10. The retail facility control system of claim 1, further comprises:
a simulator module configured to be executed by the control circuit to run a simulation of one or more site operational events based on a digital representation of at least one system executed operation and at least one human executed operation predicting states of operation corresponding to the site operational events and evaluate whether the predicted states meet the recommended operational plan.

11. The retail facility control system of claim 10, further comprising:
a site optimization module configured to be executed by the control circuit to direct control of retail facility operational subsystems to implement the recommended operational plan at the retail facility.

12. The retail facility control system of claim 1, wherein the solver module is configured to apply a machine learning model to one or more of customer-related data, associate-related data, and retail facility-related data from multiple different retail facilities in determining the recommended operational plan.

13. The retail facility control system of claim 1, further comprises a second retail execution system associated with a second retail facility,
wherein the solver module is configured to apply a first machine learning model to the customer-related data, the associate-related data, and the retail facility-related data in determining the recommended operational plan; and
wherein the second retail execution system is configured to apply the first machine learning model to additional data corresponding to the second retail facility to determine a second recommended operational plan corresponding to the second retail facility.

14. The retail facility control system of claim 1, wherein the solver module is configured to access business priorities and operational goals defined for multiple retail facilities, and define multiple recommended operational plans each configured to be implemented at a respective one of the multiple retail facilities predicted to respectively enhance operation of each of the retail facilities consistent with one or more of the business priorities and the operational goals.

15. The retail facility control system of claim 1, wherein the solver module is configured to access business priorities and operational goals defined for a retail entity controlling multiple different retail facilities located at different geographic locations and comprising the retail facility, and define the recommended operational plan to be implemented relative to two or more of the multiple different retail facilities predicted to respectively enhance operation of each of the two or more of multiple different retail facilities consistent with one or more of the business priorities and the operational goals.

16. A method of controlling retail facilities, comprising:
storing and retrieving a plurality of products within an automated storage and retrieval system (ASRS), of a plurality of retail operational subsystems of a retail facility, to and from corresponding designated storage locations in the ASRS and facilitating fulfillment of customer orders that each include at least one product from the plurality of products;
obtaining, from a plurality of retail operational applications corresponding to the retail facility, customer-related data, associate-related data, and retail facility-related data;
receiving ASRS data associated with operation of the ASRS; and
storing the ASRS data, the customer-related data, the associate-related data, and the facility-related data;
accessing, through a solver module configured to be executed by a control circuit, business priorities and operational goals defined for the retail facility; and
defining a recommended operational plan based on the customer-related data, associate related data, retail facility-related data and the ASRS data, wherein the recommended operational plan is intended to be implemented at the retail facility and predicted to enhance operation of the retail facility consistent with one or more the business priorities and the operational goals.

17. The method of claim 16, further comprises:
applying one or more simulator machine learning models to the recommended operational plan;
simulating events at the retail facility predicting future states; and
evaluating the predicted future states relative to the recommended operational plan.

18. The method of claim 16, further comprises:
iteratively defining multiple recommended operational plans that could be implemented at the retail facility and predicted to enhance operation of the retail facility consistent with one or more of the business priorities and the operational goals.

19. The method of claim 18, further comprises:
applying one or more simulator machine learning models to each of the multiple recommended operational plans and simulating events at the retail facility predicting future states; and
evaluating the predicted future states relative to one or more of the multiple recommended operational plans and identifying a first recommended operational plan of the multiple recommended operational plans predicted to satisfy an optimization criteria within a criteria threshold.

20. The method of claim 16, further comprising:
simulating one or more site operational events based on a digital representation of at least one system executed operation and at least one human executed operation and predicting states of operation corresponding to the site operational events and
evaluating whether the predicted states meet the recommended operational plan.
